(19) United States
(12) Patent Application Publication
(10) Pub. No.: US 2009/0142687 A1
(43) Pub. Date: Jun. 4, 2009

(54) TONER AND METHOD FOR MANUFACTURING THE TONER, TWO-COMPONENT DEVELOPER, DEVELOPING DEVICE AND IMAGE FORMING APPARATUS

(76) Inventors: Satoru Ariyoshi, Nara-shi (JP); Masahiko Kubo, Nara-shi (JP); Yoshiaki Akazawa, Nara-shi (JP)

Correspondence Address: NIXON & VANDERHYE, PC, 901 NORTH GLEBE ROAD, 11TH FLOOR, ARLINGTON, VA, 22203, US

(21) Appl. No.: 12/325,449

(22) Filed: Dec. 1, 2008

(30) Foreign Application Priority Data
Nov. 29, 2007 (JP) P2007-309188

(51) Int. Cl. G03G 9/087; G03G 9/00

(52) U.S. Cl. 430/109.4; 430/105; 430/109.1; 430/137.2

(57) ABSTRACT

A toner which takes into account preservation of the global environment and which is excellent in fixability and storage stability and moreover, good in light transmittance and a method for manufacturing the toner, a two-compartment developer, a developing device and an image forming apparatus are provided. In toner including at least a binder resin and a colorant, the binder resin includes a resin which is a major component and a biomass-containing crystalline resin; and the crystalline resin is contained in an amount of 1 part by weight or more and 50 parts by weight or less based on 100 parts by weight of the binder resin, and a melting point of the crystalline resin is higher by a temperature of from 5° C. to 10° C. than a temperature at which a loss modulus G″ of the toner at a frequency of 1 Hz is 10³ Pa.

### CROSS-REFERENCE TO RELATED APPLICATION

The application claims priority to Japanese Patent Application No. 2007-309188, which was filed on Nov. 29, 2007, the contents of which are incorporated herein by reference in its entirety.

### BACKGROUND OF THE INVENTION

1. Field of the Invention

The present invention relates to a toner and a method for manufacturing the toner, a two-component developer, a developing device and an image forming apparatus.

2. Description of the Related Art

A toner capable of visualizing a latent image is used in various image forming processes, and as an example thereof, it is known that the toner is used in an image forming process of an electrophotographic system.

In an image forming apparatus utilizing an image forming process of an electrophotographic system, in general, a desired image is formed on a medium by executing a charging step of uniformly charging a photosensitive layer on the surface of a photoreceptor drum which is a latent image bearing member; an exposure step of projecting signal light of an original image onto the surface of the photoreceptor drum in a charged state, thereby forming an electrostatic latent image; a development step of supplying an electrophotographic toner to the electrostatic latent image on the surface of the photoreceptor drum, thereby achieving visualization; a transfer step of transferring the toner image on the surface of the photoreceptor drum onto a medium such as paper or an OHP sheet; a fixing step of fixing the toner image onto the medium by heating, applying a pressure or the like; and a cleaning step of removing the toner or the like which remains on the surface of the photoreceptor drum after toner image transfer by a cleaning blade, thereby achieving cleaning. There may be the case where the transfer of the toner image onto the medium is carried out via an intermediate transfer medium. A developer which is used for such an image forming apparatus includes a one-component developer containing only a toner as a major component and a two-component developer to be used upon mixing a toner and a carrier. Also, the toner which is used for such a developer is manufactured by a polymerization method represented by, for example, a kneading pulverization method, a suspension polymerization method or an emulsion polymerization cohesion method. In the kneading pulverization method, the toner is manufactured by melt-kneading a toner raw material containing a binder resin and a colorant as major components and having optionally a release agent, a charge control agent, etc. added and mixed therein, cooling it for solidification and then pulverizing and classifying the solid.

In recent years, from the viewpoint of preservation of the global environment, a lot of grappling has been made in various technical fields. At present, though raw materials of a number of products are manufactured from petroleum, grappling with reduction of carbon dioxide to be generated at the time of manufacture, incinerator or the like of such a raw material or necessary energy or the like is very important from the viewpoint of prevention of the global warming.

For that reason, as new grappling leading to prevention of the global warming, utilization of plant-based resources which are called a biomass attracts great attention. Carbon dioxide which is generated during the incineration of a biomass is originally carbon dioxide in air, which a plant takes therein by photosynthesis. Therefore, the balance of carbon dioxide in air is zero on the whole, and the total amount does not change. In this way, properties which do not influence increase and decrease of carbon dioxide in air are called “carbon neutrality”, and by utilizing a carbon-neutral plant-based resource, the amount of carbon dioxide in air can be fixed. A plastic to be manufactured from such a biomass is called a biomass polymer, a biomass plastic, a non-petroleum based polymer material or the like, and a monomer which is a raw material for such a material is called a biomass monomer.

Even in the field of electrophotography, taking into account preservation of the global environment, there is made grappling utilizing a biodegradable resin containing a biomass as a resource which is excellent in environmental safety and effective for reducing carbon dioxide.

For example, in general, a polyester resin is manufactured by condensation polymerization of a dicarboxylic acid and a diol. There is proposed a technology for using, as a binder resin for color toner, a polyester resin which is manufactured by using, as the dicarboxylic acid component, a biomass monomer such as succinic acid or itaconic acid and, as the diol component, a biomass monomer such as 1,3-propanediol.

There is also proposed a technology for using, as a binder resin for toner, a polylactic acid resin which is a biomass polymer to be manufactured by using, as a raw material, lactic acid which is obtainable from a plant such as corn. Since the polylactic acid resin can be processed into various forms, it has the potential to become a new general-purpose resin and has already been sold on an industrial scale.

For example, Japanese Unexamined Patent Publication JP-A 2001-22123 discloses a toner for electrophotography which is a toner including a binder resin and a colorant and being especially optimal for a flash fixing system, wherein the toner reveals an excellent fixing ration of toner and has high safety against a human body or an environment by configuring the binder resin so as to include a combination of a resin of an ester type structure and a polylactic acid resin. Also, Japanese Unexamined Patent Publication JP-A 2004-184444 discloses a toner for electrostatic charge image development which is a toner containing a binder resin, a colorant and a charge control agent, wherein when the binder resin contains a biodegradable resin such as a polylactic acid resin, and the charge control agent contains a polyamine having a repeating structure, during the continuous printing, the toner exhibits a stable charge behavior, is able to provide a good image free from fluctuation in image density and has high safety against an environment.

Also, as other grappling leading to prevention of the global warming, conservation of energy is studied from various angles. In the field of electrophotography, recognition that a reduction of fixing energy by decreasing the fixing temperature of a toner which has been transferred onto a medium such as paper or an OHP sheet is effective is increasing. Also, realization of a higher speed of a copier or a facsimile machine is desired. In view of these trends, it is necessary and indispensable to realize a low melting point of the toner.

As a method of fixing a toner image which has been transferred onto a medium such as a paper or an OHP sheet, there is often adopted a contact heating-type fixing system for heat melting a toner image by a heating roller or the like and fixing it upon applying a pressure. Fixability of the toner in this system can be evaluated by a fixable temperature width of from a lower limit temperature of fixation to a hot offset initiation temperature. The realization of a low melting point of the toner as referred to herein is to decrease the lower limit temperature of fixation, whereby realization of low-temperature fixation can be achieved. For the binder resin for toner, a resin having a crosslinking structure, a resin including a high molecular weight material and a low molecular weight material and the like are useful. In such a binder resin, when the content of the crosslinking component or high molecular weight material component is increased for the purpose of enhancing hot offset resistance, a melt viscosity of the resin becomes too high so that there is a possibility that the low-temperature fixability of the toner is insufficient. On the other hand, when the content of the low molecular weight material is increased for the purpose of enhancing the low-temperature fixability, though the melt viscosity of the resin is low, there is a possibility that elasticity of the toner is lowered, whereby the hot offset resistance is lowered. Accordingly, for the purposes of achieving the realization of a low melting point of the toner and moreover, maintaining the offset resistance at a high temperature, it is especially important to design a binder resin for toner.

Also, for the purposes of achieving low-temperature fixation and reducing fixing energy, there is proposed a technology disclosed in Japanese Unexamined Patent Publication JP-A 2002-72567. JP-A 2002-72567 discloses a full-color image forming method of using a developer containing a toner comprising toner particles each composed of at least a colorant and a binder resin containing a crystalline resin which is a major component, wherein the toner has a melting point of from 50° C. to 120° C., and a crystal of the crystalline resin in a fixed image has a size of 3 μm in average.

According to the technologies disclosed in JP-A 2001-22123 and JP-A 2004-184444, it is difficult to uniformly disperse polylactic acid in the toner due to a difference in physical properties between the resin which is a major component of the binder resin for toner and polylactic acid or the like. In the case where polylactic acid is non-uniformly dispersed in the toner, there is a possibility that not only an influence against fixability due to scattering in particle size distribution to be caused due to deviation of pulverization properties of the toner or scattering In melt viscosity and deviation of physical properties among the toner particles such as scattering in charging properties due to deviation of a resin composition or the like are generated, but scattering or deterioration in light transmittance is generated.

Also, according to the technology disclosed in JP-A 2002-72567, the low-temperature fixability is enhanced by decreasing the lower limit temperature of fixation of the binder resin without lowering a glass transition point while utilizing sharp melt properties of the crystalline resin. However, sufficient low-temperature fixability and hot offset resistance are not obtained, and good storage stability is not obtained. Also, in the fixation on the medium such as paper or an OHP sheet, when the crystalline resin is recrystallized upon melting and subsequent cooling for solidification, the dispersion state of the crystalline resin becomes non-uniform so that there is a possibility that deviation in light transmittance is generated.

### SUMMARY OF THE INVENTION

The invention has been made in view of the foregoing problems, and an object thereof is to provide a toner which takes into account preservation of the global environment and which is excellent in fixability and storage stability and moreover, good in light transmittance and a method for manufacturing the toner, a two-component developer, a developing device and an image forming apparatus.

The invention provides a toner comprising at least a binder resin and a colorant,

the binder resin including a resin which is a major component, and a biomass-containing crystalline resin, and

the crystalline resin being contained in an amount of 1 part by weight or more and 50 parts by weight or less based on 100 parts by weight of the binder resin, and a melting point of the crystalline resin being higher by a temperature of from 5° C. to 10° C. than a temperature at which a loss modulus G″ of the toner at a frequency of 1 Hz is 10³ Pa.

According to the invention, in the toner which comprises at least a binder resin and a colorant, the binder resin includes a resin which is a major component, and a biomass-containing crystalline resin.

In this way, when the binder resin includes a resin which is a major component, it is possible to control its molecular weight distribution so as to have an optimal value for the purpose of obtaining excellent low-temperature fixability. Also, when the binder resin includes a biomass-containing crystalline resin, it is possible to obtain a carbon-neutral toner which takes into account preservation of the global environment. Furthermore, it is possible to obtain excellent hot offset resistance by a filler effect to be caused due to dispersion of the foregoing crystalline resin in the toner. Accordingly, fixability and storage stability can be kept good.

Also, when the crystalline resin is contained in an amount of 1 part by weight or more and 50 parts by weight or less based on 100 parts by weight of the binder resin, it is possible to keep dispersibility of the crystalline resin in the toner good.

Furthermore, when a melting point of the crystalline resin is higher by a temperature of from 5° C. to 10° C. than a temperature at which a loss modulus G″ of the toner at a frequency of 1 Hz is 10³ Pa, it is possible to fix the toner at a temperature at which the crystalline resin is not melted. Hence, the dispersion state of the crystalline resin can be maintained, and good fixability can be obtained. Also, it is possible to prevent the matter that the dispersion state becomes non-uniform due to recrystallization after the fixation from occurring, and therefore, deterioration of the light transmittance can be suppressed.

Accordingly, the toner of the invention is a toner which takes into account preservation of the global environment and which is excellent in fixability and storage stability and moreover, good in light transmittance.

Also, in the invention, it is preferable that the crystalline resin includes a unit represented by the following formula (1):

—[O—CH(CH₃)—CO]ₙ— (1)

wherein n represents a positive integer.

According to the invention, it is possible to obtain a toner which much more takes into account preservation of the global environment and which is excellent in environmental safety and effective for reducing carbon dioxide.

Also, in the invention, it is preferable that the resin which is a major component is a polyester resin.

According to the invention, it is possible to obtain a toner having both excellent sharp melt properties and durability and being optimal for a color toner. Also, it is possible to obtain a color toner having excellent low-temperature fixability and excellent color forming properties.

Also, in the invention, it is preferable that a loss modulus G″ of the toner at 120° C. is 10⁵ Pa or less, and a loss modulus G″ of the toner at 200° C. is 10¹ Pa or more, and a loss tangent which is a value obtained by dividing the loss modulus G″ at 200° C. by a storage modulus G′ is 10 or less.

According to the invention, it is possible to obtain a sufficient fixable temperature width of from a lower limit temperature of fixation to a hot offset initiation temperature, which is an index of fixability of the toner.

Also, the Invention provides a method for manufacturing the toner mentioned above, comprising:

a premixing step of mixing a binder resin which includes at least a resin which is a major component, and a biomass-containing crystalline resin and a colorant to prepare a mixture;

a melt-kneading step of melt-kneading the mixture containing the crystalline resin in an amount of 1 part by weight or more and 50 parts by weight or less based on 100 parts by weight of the binder resin to prepare a melt-kneaded material;

a pulverization step of pulverizing the melt-kneaded material to prepare a pulverized material; and

a classification step of removing an excessively-pulverized material and a coarse powder from the pulverized material.

According to the invention, the method for manufacturing the foregoing toner includes a premixing step of mixing a binder resin which includes at least a resin which is a major component, and a biomass-containing crystalline resin and a colorant to prepare a mixture; a melt-kneading step of melt-kneading the mixture containing the crystalline resin in an amount of 1 part by weight or more and 50 parts by weight or less based on 100 parts by weight of the binder resin to prepare a melt-kneaded material; a pulverization step of pulverizing the melt-kneaded material to prepare a pulverized material; and a classification step of removing an excessively-pulverized material and a coarse powder from the pulverized material.

In this way, it is possible to manufacture the toner of the invention which takes into account preservation of the global environment and which is excellent in fixability and storage stability and moreover, good in light transmittance at low costs by using the simplest equipment among various manufacturing methods of a toner.

Also, in the invention, it is preferable that the mixture is melt-kneaded using a two-roller type continuous kneading machine in the melt-kneading step.

According to the invention, when the mixture is melt-kneaded using a two-roller type continuous kneading machine in the melt kneading step, dispersibility of the toner raw material is much more enhanced as compared with the case of using a conventional other kneading machine. Accordingly, uniformity of the crystalline resin in the toner is enhanced, and fine dispersion is achieved. Thus, deterioration of the light transmittance can be prevented from occurring. Furthermore, the hot offset resistance due to a filler effect of the crystalline resin can be enhanced.

Also, the invention provides a two-component developer comprising the toner mentioned above and a carrier.

According to the invention, when the two-component developer of the invention includes the foregoing toner and a carrier, it is possible to obtain a two-component developer which takes into account preservation of the global environment and which is excellent in fixability and storage stability and moreover, good in light transmittance.

Also, the invention provides a developing device performing development by use of the toner mentioned above or the two-component developer mentioned above.

According to the invention, in the developing device of the invention, when the development is performed by use of the toner mentioned above or the two-component developer mentioned above, it is possible to maintain storage stability while ensuring fixability of the toner. Therefore, it is also possible to maintain a stable performance against a stress such as stirring within a development tank.

Also, the invention provides an image forming apparatus comprising the developing device mentioned above.

According to the invention, in the image forming apparatus of the invention, when the developing device of the invention is provided, it is possible to form a stable image with high image quality which is excellent in fixability and color forming properties without generating a trouble over a long period of time.

Also, in the invention, it is preferable that the image forming apparatus further comprises a fixing section for heat-melting and fixing a toner image formed on a recording medium.

According to the invention, by forming a fixed image using the toner of the invention by the image forming apparatus provided with the above-mentioned fixing section, it is possible to obtain an image with high image quality which effectively brings out physical properties of the toner having both low-temperature fixability and storage stability.

### BRIEF DESCRIPTION OF THE DRAWINGS

Other and further objects, features, and advantages of the invention will be more explicit from the following detailed description taken with reference to the drawings wherein:

FIG. 1 is a flow chart showing an example of procedures in the method for manufacturing a toner according to the invention;

FIG. 2 is a cross-sectional view schematically showing an example of a configuration of an image forming apparatus according to the invention; and

FIG. 3 is a cross-sectional view schematically showing an example of a configuration of a developing device according to the invention.

### DETAILED DESCRIPTION

Now referring to the drawings, preferred embodiments of the invention are described below.

The toner of the invention is a toner comprising at least a binder resin and a colorant, wherein the binder resin includes a resin which is a major component and a biomass-containing crystalline resin, and the crystalline resin is contained in an amount of 1 part by weight or more and 50 parts by weight or less based on 100 parts by weight of the binder resin, and a melting point of the crystalline resin is higher by a temperature of from 5° C. to 10° C. than a temperature at which a loss modulus G″ of he toner at a frequency of 1 Hz is 10³ Pa.

In this way, when the binder resin includes a resin which is a major component, it is possible to control its molecular weight distribution so as to have an optimal value for the purpose of obtaining excellent low-temperature fixability. Also, when the binder resin includes a biomass-containing crystalline resin, it is possible to obtain a carbon-neutral toner which takes into account preservation of the global environment. Furthermore, it is possible to excellent hot offset resistance by a filler effect to be caused due to dispersion of the foregoing crystalline resin in the toner. Accordingly, fixability and storage stability good can be kept good.

Also, when the crystalline resin is contained in an amount of 1 part by weight or more and 50 parts by weight or less based on 100 parts by weight of the binder resin, it is possible to keep dispersibility of the crystalline resin in the toner good.

Furthermore, when a melting point of the crystalline resin is higher by a temperature of from 5° C. to 10° C. than a temperature at which a loss modulus G″ of the toner at a frequency of 1 Hz is 10³ Pa it is possible to fix the toner at a temperature at which the crystalline resin is not melted. Hence, the dispersion state of the crystalline resin can be maintained, and good fixability can be obtained. Also, it is possible to prevent the matter that the dispersion state becomes non-uniform due to recrystallization after the fixation from occurring, and therefore, deterioration of the light transmittance can be suppressed.

The temperature at which a loss modulus G″ of the toner at a frequency of 1 Hz is 10³ Pa as referred to herein is a temperature corresponding to a fixing temperature of the toner. The fixing temperature of the toner as referred to herein is a setting temperature of the fixing device in a heating roller fixing system and is a temperature substantially in the vicinity of the center of a fixable temperature width.

Accordingly, the toner of the invention is a toner which takes into account preservation of the global environment and which is excellent in fixability and storage stability and moreover, good in light transmittance.

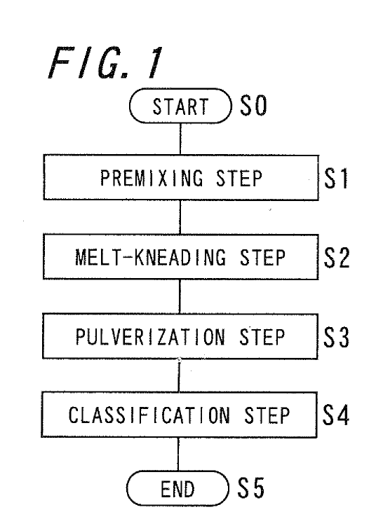

The method for manufacturing a toner according to the invention is hereunder described. The method for manufacturing a toner according to the invention is, for example, a method for manufacturing a toner as shown in a flow chart of FIG. 1. FIG. 1 is a flow chart showing an example of procedures in the method for manufacturing a toner according to the invention.

As shown in FIG. 1, the method for manufacturing a toner according to the invention includes a premixing step of mixing a binder resin including at least a resin which is a major component and a biomass-containing crystalline resin and a colorant to prepare a mixture (Step S1); a melt-kneading step of melt-kneading the mixture containing the crystalline resin in an amount of 1 part by weight or more and 50 parts by weight or less based on 100 parts by weight of the binder resin to prepare a melt-kneaded material (Step S2); a pulverization step of pulverizing the melt-kneaded material to prepare a pulverized material (Step S3); and a classification step of removing an excessively-pulverized material and a coarse powder from the pulverized material (Step S4).

Each of the manufacturing steps including Steps S1 to S4 is hereunder described in detail. When the step proceeds from Step S0 to Step S1, the manufacture of the toner of the invention is started.

### [Premixing Step]

In the premixing step of Step S1, at least a binder resin and a colorant are dry-mixed by a mixing machine to prepare a mixture. The mixture may contain other toner additive components in addition to the binder resin and the colorant. Examples of other toner additive components include a release agent and a charge control agent.

As the mixing machine to be used for dry mixing, those which are publicly known can be used. Examples thereof include mixing devices of a Henschel type, such as HENSCHEL MIXER (a trade name: FM MIXER, manufactured by Mitsui Mining Co., Ltd.), SUPER MIXER (a trade name, manufactured by KAWATA MFG Co., Ltd.) or MECHANOMILL (a trade name, manufactured by Okada Seiko Co., Ltd.), ANGMILL (a trade name, manufactured by Hosokawa Micron Corporation), HYBRIDIZATION SYSTEM (a trade name, manufactured by Nara Machinery Co., Ltd.) and COSMOSYSTEM (a trade name, manufactured by Kawasaki Heavy Industries, Ltd.).

Each of the raw materials of the toner to be contained in the mixture is hereunder described.

### (a) Binder Resin

The binder resin to be contained in the toner of the invention includes a resin which is a major component and a biomass-containing crystalline resin.

When the binder resin includes a resin which is a major component, it is possible to control its molecular weight distribution so as to have an optimal value for the purpose of obtaining low-temperature fixability. Also, when the binder resin includes a biomass-containing crystalline resin, it is possible to obtain a carbon-neutral toner which takes into account preservation of the global environment. Furthermore, it is possible to obtain excellent hot offset resistance by a filler effect to be caused due to dispersion of the foregoing crystalline resin in the toner. Accordingly, fixability and storage stability can be kept good.

As the resin which is a major component, general thermoplastic resins can be used. Examples thereof include polyester resins, acrylic resins, polyurethane resins and epoxy resins. These resins may be used each alone, or two or more of them may be used in combination. Also, in resins of the same kind, two or more of resins which are different from each other in any one or plurality of physical properties including molecular weight and monomer composition may be used in combination.

The polyester resin is not particularly limited, and those which are publicly known can be used. Examples thereof include condensation polymerization products between a polybasic acid and a polyhydric alcohol. The polybasic acid as referred to herein refers to a polybasic acid or a derivative of a polybasic acid, for example, acid anhydrides or esterification products of a polybasic acid. The polyhydric alcohol as referred to herein refers to a compound containing two or more hydroxyl groups therein and includes all of alcohols and phenols.

As the polybasic acid, those which are commonly used as a monomer of a polyester resin can be used. Examples thereof include aromatic carboxylic acids such as terephthalic acid, isophthalic acid, phthalic anhydride, trimellitic anhydride, pyromellitic acid or naphthalenedicarboxylic acid; and aliphatic carboxylic acids such as maleic anhydride, fumaric acid, succinic acid or adipic acid. The polybasic acid may be used each alone, or two or more of them may be used in combination.

As the polyhydric alcohols those which are commonly used as a monomer of a polyester resin are useful. Examples thereof include aliphatic polyhydric alcohols such as ethylene glycol, propylene glycol, butanediol, hexanediol, neopentyl glycol or glycerin; alicyclic polyhydric alcohols such as cyclohexanediol, cyclohexanedimethanol or hydrogenated bisphenol A; and aromatic diols such as an ethylene oxide adduct of bisphenol A or a propylene oxide adduct of bisphenol A. The “bisphenol A” as referred to herein refers to 2,2-bis(4-hydroxyphenyl)propane. Examples of the ethylene oxide adduct of bisphenol A include polyoxyethylene-2,2-bis(4-hydroxyphenyl)propane. Examples of the propylene oxide adduct of bisphenol A include polyoxypropylene-2,2-bis(4-hydroxyphenyl)propane. The polyhydric alcohol may be used each alone, or two or more of them may be used in combination.

The polyester resin can be synthesized through a condensation polymerization reaction. For example, the polyester resin can be synthesized through a polycondensation reaction, specifically a dehydration condensation reaction between a polybasic acid and a polyhydric alcohol in an organic solvent or under a solvent-free condition in the presence of a catalyst. At that time, a demethanol polycondensation reaction may be carried out by using a methyl esterification product of a polybasic acid in a part of the polybasic acid. The polycondensation reaction between a polybasic acid and a polyhydric alcohol may be finished when an acid number and a softening temperature of the formed polyester resin have reached values in a polyester resin to be synthesized. In this polycondensation reaction, other physical properties such as a softening temperature can also be regulated by properly changing a reaction condition such as a blending ratio or reactivity between the polylactic acid and the polyhydric alcohol, for example, by regulating the content of a carboxyl group bonding to an end of the obtained polyester resin, in its turn an acid number of the obtained polyester resin.

The acrylic resin is not particularly limited, too, and those which are publicly known can be used. Examples thereof include homopolymers of an acrylic monomer and copolymers of an acrylic monomer and a vinyl based monomer. Among them, acid group-containing acrylic resins are preferable. As the acrylic monomer, those which are commonly used as a monomer of an acrylic resin can be used. Examples thereof include acrylic acid; methacrylic acid; acrylic ester based monomers such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, n-octyl acrylate, decyl acrylate or dodecyl acrylate; and methacrylic ester based monomers such as methyl methacrylate, propyl methacrylate, n-butyl methacrylate, isobutyl methacrylate, n-amyl methacrylate, n-hexyl methacrylate, 2ethylhexyl methacrylate, n-octyl methacrylate, decyl methacrylate or dodecyl methacrylate. These acrylic monomers may have a substituent. Examples of the substituent-containing acrylic monomer include hydroxyl group-containing acrylic ester based or methacrylic ester based monomers such as hydroxyethyl acrylate or hydroxypropyl methacrylate. The acrylic monomer may be used each alone, or two or more of them may be used in combination. As the vinyl based monomer, those which are publicly known are useful, too. Examples thereof include aromatic vinyl monomers such as styrene or α-methylstyrene; aliphatic vinyl monomers such as vinyl bromide, vinyl chloride or vinyl acetate; and acrylonitrile based monomers such as acrylonitrile or methacrylonitrile. The vinyl based monomer may be used each alone, or two or more of them may be used in combination.

The acrylic resin can be, for example, manufactured by polymerizing one or two or more of an acrylic monomer, or one or two or more of an acrylic monomer and one or two or more of a vinyl monomer in the presence of a radical polymerization initiator by a solution polymerization method, a suspension polymerization method or an emulsion polymerization cohesion method or the like. The acid group-containing acrylic resin can be, for example, manufactured by using either one or both of an acid group or hydrophilic group-containing acrylic monomer and an acid group or hydrophilic group-containing vinyl based monomer in polymerizing an acrylic monomer or an acrylic monomer and a vinyl based monomer.

The polyurethane resin is not particularly limited, too, and those which are publicly known can be used. Examples thereof include addition polymerization products between a polyol and a polyisocyanate. Among them, acid group or basic group-containing polyurethane resins are preferable. The acid group or basic group-containing polyurethane resin can be, for example, synthesized through an addition polymerization reaction between an acid group or basic group-containing polyol and a polyisocyanate. Examples of the acid group or basic group-containing polyol include diols such as dimethylolpropionic acid or N-methyldiethanolamine; polyether polyols such as polyethylene glycol; and trihydric or polyhydric polyols such as polyester polyols, acrylic polyols or polybutadiene polyols. The polyol may be used each alone, or two or more of them may be used in combination. Examples of the polyisocyanate include tolylene diisocyanate, hexamethylene diisocyanate and isophorone diisocyanate. The polyisocyanate may be used each anole, or two or more of them may be used in combination.

The epoxy resin is not particularly limited, too, and those which are publicly known can be used. Examples thereof include a bisphenol A type epoxy resin which is synthesized from bisphenol A and epichlorohydrin; a phenol novolak type epoxy resin which is synthesized from epichlorohydrin as well as phenol novolak which is a reaction product between phenol and formaldehyde; and a cresol novolak type epoxy resin which is synthesized from epichlorohydrin as well as cresol novolak which is a reaction product between cresol and formaldehyde. Among them, acid group or basic group-containing epoxy resins are preferable. The acid group or basic group-containing epoxy resin can be, for example, manufactured by using the foregoing epoxy resin as a basis material and adding or addition polymerizing a polybasic carboxylic acid such as adipic acid or trimellitic anhydride or an amine such as dibutylamine or ethylenediamine to this epoxy resin as a basis material.

In the binder resin, the resin which is a major component is preferably a polyester resin among the foregoing resins. When a polyester resin is used as the resin which is a major component of the binder resin, it is possible to obtain a toner having both excellent sharp melt properties and durability and being optimal for a color toner. Also, the polyester resin has a low softening temperature (T_{1/2}) as compared with other resins such as acrylic resins, and therefore, by using the polyester resin, it is possible to obtain a toner with excellent low-temperature fixability, which is able to be fixed at a lower temperature. Furthermore, the polyester resin is excellent in transmittance, and therefore, by using the polyester resin, it is possible to obtain a color toner which is excellent in color forming properties and excellent in color forming properties of a secondary color to be prepared by superimposing a toner of other color.

A glass transition temperature (Tg) of the resin which is a major component is not particularly limited and can be properly chosen over a wide range. Taking into account fixability and storage stability of the obtained toner, the glass transition temperature (Tg) of the resin which is a major component is preferably 30° C. or higher and 80° C. or lower. When the glass transition temperature (Tg) of the resin which is a major component is lower than 30° C., the storage stability is insufficient so that thermal aggregation of the toner in the inside of the image forming apparatus is easy to occur. Thus, there is a possibility that development failure is generated. Also, a temperature at which the generation of a hot offset phenomenon starts (hereinafter referred to as “hot offset initiation temperature”) is lowered. The “hot offset phenomenon” as referred to herein refers to a phenomenon in which in fixing a toner onto a recording medium by heating and applying a pressure with a fixing member such as a heating roller, the toner is overheated, whereby a cohesive power of toner particles is lower than an adhesive strength between the toner and the fixing member, the toner layer is divided, and a part of the toner attaches to the fixing member and is removed away. Also, when the glass transition temperature (Tg) of the resin which is a major component exceeds 80° C., fixability is lowered, and therefore, there is a possibility that fixing failure is generated.

Though the softening temperature (T_{1/2}) of the resin which is a major component is not particularly limited and can be properly chosen over a wide range, it is preferably 150° C. or lower, and more preferably 60° C. or higher and 120° C. or lower. When the softening temperature (T_{1/2}) of the resin which is a major component is lower than 60° C., storage stability of the toner is lowered; thermal aggregation of the toner in the inside of the image forming apparatus is easy to occur, and the toner cannot be stably supplied into an image bearing member. Thus, there is a possibility that development failure is generated. Also, there is a possibility that a fault of the image forming apparatus is induced When the softening temperature (T_{1/2}) of the resin which is a major component exceeds 120° C., since the binder resin is hardly melted in the melt-kneading step, kneading of the respective raw materials of the toner is difficult. Thus, there is a possibility that dispersibility of a colorant, a release agent, a charge control agent and the like in the melt-kneaded material is lowered. Also, in fixing the toner onto the recording medium, the toner is hardly melted or softened, and therefore, fixability of the toner to a medium (recording medium) is lowered. Thus, there is a possibility that fixing failure is generated.

Though a molecular weight of the resin which is a major component is not particularly limited and can be properly chosen over a wide range, it is preferably 5,000 or more and 500,000 or less in terms of weight average molecular weight (Mw). When the weight average molecular weight of the resin which is a major component is lower than 5,000, mechanical strength of the binder resin is lowered; the obtained toner particle is easily pulverized by stirring in the inside of the developing device or the like; and the shape of the toner particle changes. Thus, for example, there is a possibility that scattering in charging performance is generated. Also, when the weight average molecular weight of the resin which is a major component exceeds 500,000, since the resin is hardly melted, kneading in the melt-kneading step is difficult so that there is a possibility that dispersibility of a colorant, a release agent, a charge control agent and the like in the melt-kneaded material s lowered. Also, fixability of the toner is lowered, and therefore, there is a possibility that fixing failure is generated. Here, the weight average molecular weight is a value as measured by gel permeation chromatography (abbreviated as GPC) and reduced into polystyrene.

The crystalline resin is not particularly limited so far as it is one containing a biomass. Examples of the biomass include lactic acid based polymers, specifically polylactic acid resins and copolymers of lactic acid and other hydroxycarboxylic acid. Examples of other hydroxycarboxylic acid which is used as a comonomer include glycolic acid, hydroxybutyric acid, hydroxyvaleric acid, hydroxypentanoic acid, hydroxycaproic acid and hydroxypentanoic acid. The ongoing lactic acid based polymers are a carbon-neutral biomass polymer.

Such a lactic acid based polymer can be obtained by selecting a raw material having a necessary structure among L-lactic acid, D-lactic acid and other hydroxycarboxylic acids and subjecting it to dehydration condensation polymerization. In particular, it is preferable to obtain such a lactic acid based polymer by selecting a raw material having a necessary structure among a lactide which is a cyclic dimer of lactic acid, a glycollide which is a cyclic dimer of glycolic acid, caprolactone and the like and subjecting it to ring opening polymerization.

In this way, the crystalline resin is preferably a lactic acid based polymer as described previously, namely one including a unit represented by the following formula (1), and more preferably a polylactic acid resin:

—[O—CH(CH₃)—CO]ₙ— (1)

where n represents a positive integer.

According to this, it is possible to obtain a toner which much more takes into account preservation of the global environment and which is excellent in environmental safety and effective for reducing carbon dioxide.

The lactide which is a raw material of the polylactic acid resin includes L-lactide which is a cyclic dimer of L-lactic acid; D-lactide which is a cyclic dimer of D-lactic acid; meso-lactide obtained through cyclic dimerization of D-lactic acid and L-lactic acid; and DL-lactide which is a racemic mixture of D-lactide and L-lactide. All of these lactides can be used in the invention.

A method for manufacturing a polylactic acid resin is not particularly limited, and methods which have hitherto been publicly known can be adopted. Examples thereof include a method of heat melting a lactide which is a cyclic dimer of lactic acid to form a uniform mixture and subjecting it to heat ring opening polymerization using a publicly known polymerization catalyst; and a method of subjecting a lactic acid monomer directly to dehydration polycondensation upon heating under a reduced pressure.

The polymerization catalyst which is used for the foregoing polymerization reaction is not particularly limited, and publicly known catalysts for polymerization of lactic acid can be used. Examples thereof include tin based compounds such as tin octylate, tin lactate, tin tartarate, tin dicaprylate, tin dilaurate, tin dipalmitate, tin distearate, tin oleate, tin α-naphthoate or tin β-naphthoate; powdered tin and tin oxide; zinc powder, zinc halides, zinc oxide and organic zinc based compounds; titanium based compounds such as tetrapropyl titanate; zirconium based compounds such as zirconium isopropoxide; antimony based compounds such as antimony trioxide; bismuth based compounds such as bismuth(III) oxide; and aluminum based compounds such as aluminum oxide or aluminum isopropoxide. For example, in the case of carrying out ring opening polymerization, a use amount of such a polymerization catalyst is from about 0.001% by weight to 5% by weight relative to the lactide. The polymerization reaction can be usually carried out at a temperature of from 100° C. to 220° C. in the presence of the foregoing polymerization catalyst, the temperature of which, however, varies with a species of the catalyst.

Though a molar ratio of the D-lactic acid unit to the L-lactic acid unit in the polylactic acid resin is not particularly limited, it may be properly chosen such that the melting point or the like falls within a desired numerical value range.

The crystalline resin is contained in an amount of preferably 1 part by weight or more and 50 parts by weight or less, and especially preferably 10 parts by weight or more and 40 parts by weight or less based on 100 parts by weight of the binder resin. When the content of the crystalline resin is 1 part by weight or more and 50 parts by weight or less, dispersibility of the crystalline resin in the toner can be kept good. When the content of the crystalline resin exceeds 50 parts by weight, it is difficult to obtain optimal molecular weight distribution for the low-temperature fixation, and thus, there is a possibility that the fixability is deteriorated. Also, there is a possibility that melt-kneading of the respective raw materials of the toner is difficult. When the content of the crystalline resin is less than 1 part by weight, there is a possibility that an effect obtainable by containing the crystalline resin is not sufficiently obtained.

A melting point (Tm) of the crystalline resin is higher by a temperature of from 5° C. to 10° C. than a temperature at which a loss modulus G″ of the toner at a frequency of 1 Hz is 10³ Pa. According to this, it is possible to fix the toner at a temperature at which the crystalline resin in the toner is not melted. Hence, the dispersion state of the crystalline resin can be maintained, and good fixability can be obtained. Also, it is possible to prevent the matter that the dispersion state becomes nonuniform due to recrystallization of the crystalline resin after the fixation from occurring, and therefore, deterioration of the light transmittance can be suppressed. For that reason, the toner of the invention is a toner which is free from deviation in uniformity of light transmittance and optimal for a color toner. The “recrystallization” as referred to herein refers to a phenomenon in which in fixing onto a medium such as paper or an OHP sheet, the crystalline resin is again crystallized upon melting and subsequent cooling for solidification.

When the melting point (Tm) of the crystalline resin exceeds a temperature higher by 10° C. than a temperature at which a loss modulus G″ of the toner at a frequency of 1 Hz is 10³ Pa, there is a possibility that fixability and storage stability are deteriorated. Also, when the melting point (Tm) of the crystalline resin is lower than a temperature higher by 5° C. than a temperature at which a loss modulus G″ of the toner at a frequency of 1 Hz is 10³ Pa, there is a possibility that light transmittance is deteriorated.

The melting point (Tm) as referred to in this specification refers to a temperature of an endothermic peak corresponding to fusion of a DSC curve obtained by the differential scanning calorimetry (abbreviated as DSC).

A molecular weight of the crystalline resin is not particularly limited and can be properly chosen over a wide range. A molecular weight of each of the resin which is a major component and the crystalline resin is not particularly limited and may be properly chosen so as to fall within an optimal numerical value range for the purpose of obtaining hot offset resistance and low-temperature fixability with excellent molecular weight distribution of the toner.

A glass transition temperature (Tg) of the crystalline resin is not particularly limited and may be properly chosen depending upon a combination with the resin which is a major component.

### (b) Colorant

Examples of the colorant include dyes and pigments. Among them, pigments are preferably used. Since pigments are more excellent in light fastness and color forming properties than dyes, the use of a pigment makes it possible to obtain a toner having excellent light fastness and color forming properties. As described below, specific examples of the colorant include colorants for yellow toner, colorants for magenta toner, colorants for cyan toner and colorants for black toner. In the following, a color index is abbreviated as “C.I.”.

Examples of the colorant for yellow toner include organic pigments such as C.I. Pigment Yellow 1, C.I. Pigment Yellow 5 C.I. Pigment Yellow 12, C.I. Pigment Yellow 15, C.I. Pigment Yellow 17, C.I. Pigment Yellow 74, C.I. Pigment Yellow 93, C.I. Pigment Yellow 180 or C.I. Pigment Yellow 185; inorganic pigments such as yellow iron oxide or ocher; nitro based dyes such as C.I. Acid Yellow 1; and oil-soluble dyes such as C.I. Solvent Yellow 2, C.I. Solvent Yellow 6, C.I. Solvent Yellow 14, C.I. Solvent Yellow 15, C.I. Solvent Yellow 19 or C.I. Solvent Yellow 21, each of which is classified depending upon the color index.

Examples of the colorant for magenta toner include C.I. Pigment Red 49, C.I. Pigment Red 57, C.I. Pigment Red 81, C.I. Pigment Red 122, C.I. Solvent Red 19, C.I. Solvent Red 49, C.I. Solvent Red 52, C.I. Basic Red 10 and C.I. Disperse Red 15, each of which is classified depending upon the color index.

Examples of the colorant for cyan toner include C.I. Pigment Blue 15, C.I. Pigment Blue 16, C.I. Solvent Blue 55, C.I. Solvent Blue 70, C.I. Direct Blue 25 and C.I. Direct Blue 86, each of which is classified depending upon the color index, and KET. BLUE 111.

Examples of the colorant for black toner include carbon blacks such as channel black, roller black, disc black, gas furnace black, oil furnace black, thermal black or acetylene black. An appropriate carbon black may be properly chosen among these various carbon blacks depending upon design properties of the toner to be obtained.

Other than these pigments, red pigments, green pigments and the like can be used. The colorant can be used each alone, or two or more thereof may be used in combination. Also, two or more of the same color system may be used, and one or two or more of each of different color systems may be used, too.

The colorant is preferably used in a form of a master batch. The master batch of the colorant can be, for example, manufactured by kneading a melt of a synthetic resin and a colorant. As the synthetic resin, a resin of the same kind as in the resin which is a major component in the binder resin of the toner or a resin having good compatibility with the resin which is a major component in the binder resin of the toner. Though a use proportion of the synthetic resin and the colorant is not particularly limited, a proportion of the colorant is preferably 30 parts by weight or more and 100 parts by weight or less based on 100 parts by weight of the synthetic resin. The master batch is, for example, granulated into a particle size of from about 2 mm to 3 mm and then used.

Though the content of the colorant in the toner of the invention is not particularly limited, it is preferably 4 parts by weight or more and 20 parts by weight or less based on 100 parts by weight of the binder resin. In the case of using a master batch, it is preferable to regulate a use amount of the master batch such that the content of the colorant in the toner of the invention falls within the foregoing range. When the content of the colorant is a value falling within the foregoing ranger it is possible to obtain a toner with high tinting strength while suppressing a filler effect due to the addition of the colorant. Also, it is possible to form a good image having a sufficient image density and high color forming properties and having excellent image quality. When the content of the colorant exceeds 20 parts by weight, elasticity increases due to the filler effect of the colorant, and thus, there is a possibility that fixability of the toner is lowered.

### (c) Release Agent

The release agent is added for the purpose of imparting release properties to the toner in fixing the toner onto a recording medium. Accordingly, in comparison with the case of not using a release agent, it is possible to increase the hot offset initiation temperature and to enhance the hot offset resistance. Furthermore, by melting the release agent upon heating in fixing the toner to lower a fixing initiation temperature, it is possible to enhance the low-temperature fixability.

As the release agent, those which are commonly used in this field can be used. Examples thereof include waxes. Examples of the wax include natural waxes such as paraffin wax, carnauba wax or rice wax; synthetic waxes such as polypropylene wax, polyethylene wax or Fischer-Tropsch wax; coal based waxes such as montan wax; petroleum based waxes; alcohol based waxes; and ester based waxes. The release agent may be used each alone, or two or more of them may be used in combination.

A blending amount of the release agent is not particularly limited and can be properly chosen over a wide range depending upon various conditions such as the kinds and contents of other components including the binder resin and the colorant or properties which are required for the toner to be prepared. The blending amount of the release agent Is preferably 3 parts by weight or more and 10 parts by weight or less based on 100 parts by weight of the binder resin. When the blending amount of the release agent is less than 3 parts by weight, there is a possibility that an effect for enhancing low-temperature fixability and hot offset resistance is not sufficiently revealed. When the blending amount of the release agent exceeds 10 parts by weight, dispersibility of the release agent in the melt-kneaded material is lowered, and thus, there is a possibility that a toner having a fixed performance cannot be stably obtained. Also, there is a possibility that a phenomenon called filming. In which the toner is fused in a film form on the surface of an image bearing member such as a photoreceptor, is easily generated.

A melting point (Tm) of the release agent is preferably 50° C. or higher and 150° C. or lower, and more preferably 80° C. or lower. When the melting point (Tm) of the release agent is lower than 50° C., the release agent is melted within the developing device, and thus, there is a possibility that toner particles cohere to each other, or failure such as filming on the surface of a photoreceptor is caused. When the melting point (Tm) of the release agent exceeds 150° C., when the toner is fixed onto a recording medium, the release agent cannot be sufficiently eluted, and thus, there is a possibility that an effect for enhancing hot offset resistance is not sufficiently revealed.

### (d) Charge Control Agent

The toner of the Invention may contain other toner additive components such as a charge control agent in addition to the binder resin, the colorant and the release agent. When the toner contains a charge control agent, it is possible to impart favorable charging properties to the toner. As the charge control agent, a charge control agent for positive charge control or negative charge control can be used. Examples thereof include charge control agents for positive charge control such as basic dyes, quaternary ammonium salts, quaternary phosphonium salts, aminopyrine, pyrimidine compounds, polynuclear polyamino compounds, aminosilane, nigrosine dyes and derivatives thereof, triphenylmethane derivatives, guanidine salts or amidine salts; and charge control agents for negative charge control such as oil-soluble dyes (for example, oil black, spiron black, etc.) metal-containing azo compounds, azo complex dyes, metal naphthenate salts, salicylic acid and metal complexes and metal salts of derivatives thereof (examples of the metal include chromium, zinc and zirconium), boron compounds, fatty acid soaps, long-chain alkyl carboxylates or resin acid soaps.

The charge control agent may be used each alone, or two or more of them may be used in combination. A use amount of the charge control agent is preferably 0.5 parts by weight or more and 5 parts by weight or less based on 100 parts by weight of the binder resin, and more preferably 0.5 parts by weight or more and 3 parts by weight or less based on 100 parts by weight of the binder resin. When the charge control agent is contained in an amount exceeding 5 parts by weight, the carrier is contaminated, and thus, there is a possibility that flying of the toner is generated. When the charge control agent is contained in an amount of less than 0.5 parts by weight, there is a possibility that sufficient charging properties cannot be imparted to the toner.

In the color toner, it is desirable to use a colorless charge control agent. For example, it is desirable to use salicylic acid and a metal complex or a metal salt of a derivative thereof.

### [Melt-Kneading Step]

In the melt-kneading step of Step S2, a mixture containing the crystalline resin which has been prepared in the premixing step in an amount of 1 part by weight or more and 50 parts by weight or less based on 100 parts by weight of the binder resin is melt-kneaded to prepare a melt-kneaded material. Melt-kneading of the mixture is carried out by heating at a temperature of a softening point of the binder resin or higher and lower than a heat decomposition temperature thereof to melt or soften the binder resin, thereby dispersing the respective raw materials of the toner other than the binder resin into the binder resin.

As a kneading machine to be used for melt-kneading, those which are publicly known can be used. For examples general kneading machines such as a kneader, a twin-screw extruder, a two-roller mill, a three-roller mill or a laboplast mill can be used. More specifically, there are exemplified single screw or twin-screw extruders such as TEM-100B (a trade name, manufactured by Toshiba Machine Co., Ltd.) or PCM-65/87 or PCM-30 (all of which are a trade name, manufactured by Ikegai, Ltd.); and open roller type kneading machines such as MOS 320-1800 or KNEADEX (all of which are a trade name, manufactured by Mitsui Mining Co., Ltd.). The mixture of the toner raw materials may be melt-kneaded using a plural number of kneading machines.

Among the foregoing kneading machines, it is especially preferable to use a two-roller type continuous kneading machine which is an open roller type continuous kneading machine. The two-roller type continuous kneading machine has a helical groove on the surface thereof and is provided with a heating roller and a cooling roller which mutually rotate in the inside direction.

According to the two two-roller type continuous kneading machine, the mixture of the toner raw materials obtained in the premixing step is supplied into one end on the heating roller of the open roller by a raw material conveying and supplying device constituted by a screw feeder, a vibration feeder or the like. The supplied mixture is melted by heat of the heating roller and wound around the surface of the heating roller and remains between the heating roller and the cooling roller. The melt material remaining between the both rollers is transferred into the side of the other end (the side of the end opposite to the supplying side), and a mass is kneaded due to a shearing force of the roller while remaining in a state that it is divided into several lumps, thereby preparing a melt-kneaded material.

In the two-roller type continuous kneading machine, since melt-kneading of the mixture is in general carried out at a low temperature, melting of the binder resin does not proceed, and the binder resin of a highly viscous fluid is kneaded, whereby large compression force and shearing force are generated. The pigment and additives are finely divided due to the subject compression force and shearing force and uniformly dispersed into the binder resin, whereby the mixture is melt-kneaded. Then, the prepared melt-kneaded material is discharged from the discharge side of the other end of the open roller and cooled for solidification.

In this way, when the mixture is melt-kneaded by using a two-roller type continuous kneading machine, dispersibility of the toner raw materials is much more enhanced as compared with the case of using a conventional other kneading machine. Accordingly, uniformity of the crystalline resin in the toner is enhanced, and fine dispersion is achieved. Thus, deterioration of the light transmittance can be prevented from occurring. Furthermore, the hot offset resistance due to a filler effect of the crystalline resin can be enhanced.

### [Pulverization Step]

In the pulverization step of Step S3, the melt-kneaded material obtained in the melt-kneading step is cooled for solidification and then pulverized to prepare a pulverized material. That is, the melt-kneaded material which has been cooled for solidification is first coarsely pulverized into a coarsely pulverized material having for example, a volume average particle size of 100 μm or more and 5 mm or less by a hammer mill, a cutting mill or the like. Thereafter, the obtained coarsely pulverized material is finely pulverized into a pulverized material having, for example, a volume average particle size of 15 μm or less. For fine pulverization of the coarsely pulverized material, for example, a jet pulverizer for achieving pulverization utilizing an ultrasonic jet stream, an impact pulverizer for achieving pulverization by introducing a coarsely pulverized material into a space to be formed between a rotator (rotor) rotating at a high speed and a stator (liner) or the like can be used.

The melt-kneaded material which has been cooled for solidification may be directly pulverized by a jet pulverizer, an impact pulverizer or the like without going through coarse pulverization by a hammer mill, a cutting mill or the like.

### [Classification Step]

In the classification step of Step S4, an excessively-pulverized toner particle (hereinafter often referred to as “excessively-pulverized material”) or a coarse toner particle (hereinafter often referred to as “coarse powder”) are removed from the pulverized material which has been prepared in the pulverization step by using a classifier. The excessively-pulverized toner particle or coarse toner particle can also be recovered and used for the purpose of reusing it for manufacturing other toner.

For the classification, a known classifier is usable by which the excessively-pulverized toner particles and the coarse toner particles can be removed through classification using centrifugal force or wind force. The known classifier includes, for example, a swivel pneumatic classifier (rotary pneumatic classifier).

the classification is preferably carried out by properly regulating a classification condition such that the toner particle obtained after the classification has a volume average particle size of 3 μm or more and 15 μm or less. In particular, for the purpose of obtaining an image with high image quality, it is preferable to regulate the toner particle so as to have a volume average particle size of 3 μm or more and 9 μm or less; and for the purpose of devising to further enhance the image quality, it is preferable to regulate the toner particle so as to have a volume average particle size of 5 μm or more and 8 μm or less. When the volume average particle size of the toner particle is less than 3 μm, the particle size of the toner becomes excessively small so that there is a possibility that high electrification and low fluidization occur. When such high electrification and low fluidization are generated, the toner cannot be stably supplied into a photoreceptor which is an image bearing member, and thus, there is a possibility that background fogging and a reduction of the image density are generated. When the volume average particle size of the toner particle exceeds 15 μm, the particle size of the toner is large so that an image with high definition cannot be obtained. Also, because of the matter that the particle size of the toner is large, a specific surface area is decreased, and the quantity of charging of the toner becomes low. When the quantity of charging of the toner is low, the toner is not stably supplied into the photoreceptor, and thus, there is a possibility that contamination within the machine is generated due to flying of the toner. The foregoing classification condition to be regulated refers to, for example, a speed of rotation of a classification rotor in the swivel pneumatic classifier (rotary pneumatic classifier).

In the obtained toner particle, it is preferable that a loss modulus G″ (at 120° C.) at 120° C. is 10⁵ Pa or less, and a loss modulus G″ (at 200° C.) at 200° C. is 10¹ Pa or more; and that a loss tangent which is a value obtained by dividing the loss modulus G″ at 200° C. by a storage modulus G′ is 10 or less.

By making the viscoelasticity of the toner particle fall within the foregoing range, it is possible to obtain a sufficient fixable temperature width of from a lower limit temperature of fixation to a hot offset initiation temperature, which is an index of fixability of the toner.

When the loss modulus G″ (at 120° C.) exceeds 10⁵ Pa, the viscosity of the toner is too high so that the low-temperature fixability is deteriorated. Also, when the loss modulus G″ (at 200° C.) is less than 10¹ Pa, and the loss tangent exceeds 10, the hot offset resistance is deteriorated due to insufficient elasticity of the toner.

The storage modulus G′ is a value expressing elasticity of a sample; and the loss modulus G″ is a value expressing viscosity of a sample. The loss tangent (tan δ) which is a ratio between the storage modulus G′ and the loss modulus G″ is a value G″/G′ which is obtained by dividing the loss modulus G″ by the storage modulus G′ and expresses a proportion of the viscosity to the elasticity. In general, storage modulus G′ and the loss modulus G″ of a resin with high melting properties such as a binder resin of a toner have high temperature dependency. Hence, in the invention, the storage modulus G′ and loss modulus G″ were measured by vibrating a kneaded material in a molten state while changing the temperature under a condition under which a frequency (1.0 Hz) and a strain (5%) are fixed. Then, a loss modulus-temperature characteristic curve which expresses the relationship between the loss modulus G″ and the temperature and a loss tangent-temperature characteristic curve which expresses the relationship between the loss tangent (tan δ) and the temperature were determined from the obtained measurement results, and values of the loss modulus G″ at 120° C. and 200° C. and the loss tangent (tan δ) at 200° C. were then determined from these graphs.

With respect to the temperature condition in the melt-kneading step, it is preferable to regulate the temperature at 120° C. or higher and 200° C. or lower, the range of which is a temperature range of from a softening temperature of the binder resin in the toner or higher and lower than a heat decomposition temperature. Hence, a storage modulus G′, a loss modulus G″ and a loss tangent (tan δ) in this temperature range were determined.

The thus manufactured toner particle may be mixed with, for example, an external additive bearing a function such as enhancement in powder fluidity, enhancement in triboelectrostatic properties, enhancement in heat resistance, improvement in low-term storage properties, improvement in cleaning properties or control of abrasion properties on the surface of a photoreceptor. As the external additive, those which are commonly used in this field can be used. Examples thereof include a silica fine powder, a titanium oxide fine powder and an alumina fine powder. Such an inorganic fine powder is preferably treated with a treating agent for the purpose of hydrophobilization, control of charging properties and the like, such as a silicone varnish, a modified silicone varnish of every sort, a silicone oil, a modified silicone oil of every sort, a silane coupling agent, a functional group-containing silane coupling agent or other organosilicon compound. The treating agent may be used each alone, or two or more of them may be used in combination. Taking into account the quantity of charging necessary for the toner, influences against abrasion of the photoreceptor due to the addition of an external additive, environmental properties of the toner and the like, the addition amount of the external additive is favorably 5 parts by weight or less based on 100 parts by weight of the toner particle.

The external additive preferably has a number average particle size of primary particles of from 10 nm to 500 nm. By using an external additive having such a particle size, an effect for enhancing fluidity of the toner is much more easily revealed.

In this way, the method for manufacturing a toner according to the invention includes a premixing step of mixing a hinder resin including at least a resin which is a major component and a biomass-containing crystalline resin and a colorant to prepare a mixture; a melt-kneading step of melt-kneading the mixture containing the crystalline resin in an amount of 1 part by weight or more and 50 parts by weight or less based on 100 parts by weight of the binder resin to prepare a melt-kneaded material; a pulverization step of pulverizing the melt-kneaded material to prepare a pulverized material; and a classification step of removing an excessively-pulverized material and a coarse powder from the pulverized material.

According to this, it is possible to manufacture the toner of the invention which takes into account preservation of the global environment and which is excellent in fixability and storage stability and moreover, good in light transmittance at low costs by using the simplest equipment among various toner manufacturing methods.

As described previously, the toner of the invention, in which an external additive is externally added in the toner particle as the need arises can be used as a one-component developer as it stands. Also, it can be used as a two-component developer upon being mixed with a carrier.

For the carrier, magnetic particles can be used. Specific examples of the magnetic particles include metals such as iron, ferrite, and magnetite; and alloys composed of the metals just cited and metals such as aluminum or lead. Among these examples, ferrite is preferred.

Further, the carrier can be a resin-coated carrier in which the magnetic particles are coated with resin, or a dispersed-in-resin carrier in which the magnetic particles are dispersed in resin. The resin for coating the magnetic particles includes, but is not particularly limited to, for example, an olefin-based resin, a styrene-based resin, a styrene-acrylic resin, a silicone-based resin, an ester-based resin, and a fluorine-containing polymer-based resin. The resin used for the dispersed-in-resin carrier includes, but is not particularly limited either to, for example, a styrene-acrylic resin, a polyester resin, a fluorine-based resin, and a phenol resin.

A shape of the carrier is preferably spherical or oblong Further, the volume average particle size of the carrier is not particularly limited, and in consideration of enhancement in image quality, it is preferably 10 μm to 100 μm and more preferably 50 μm or less.

In this way, by setting the volume average particle size of the carrier to be 50 μm or less, the toner and the carrier come into contact with each other more frequently, and the charge on each other particle can be controlled properly, thereby allowing for formation of a high-quality image having no fog occurring on the non-image part.

Furthermore, resistivity of the carrier is preferably 10⁸ Ω·cm or more and more preferably 10¹² Ω·cm or more. The resistivity of the carrier is a value derived from a current value obtained in a manner that the carrier is put in a container having a sectional area of 0.50 cm² followed by tapping, and a load of 1 kg/cm² is then applied to the particles put in the container, thereafter being subjected to application of voltage which generates an electric field of 1,000 V/cm between the load and a bottom electrode. When the resistivity of the carrier is small, application of bias voltage to a developing sleeve will cause the charge to be injected to the carrier, which makes the carrier particles be easily attached to the photoreceptor. Further, in this case, breakdown of the bias voltage occurs more easily.

Magnetization intensity (maximum magnetization) of the carrier is preferably 10 emu/g to 60 emu/g and more preferably 15 emu/g to 40 emu/g. The magnetization intensity depends on magnetic flux density of the developing roller. Under a condition that the developing roller has normal magnetic flux density, the magnetization intensity less than 10 emu/g will lead to a failure to exercise magnetic binding force, which may cause the carrier to be spattered. When the magnetization intensity exceeds 60 emu/g, it becomes difficult to keep a noncontact state with an image bearing member in a noncontact development where brush of the carrier is too high, and in a contact development, sweeping patterns may appear more frequently in a toner image.

A use ratio between the toner and the carrier contained in the two-component developer is not particularly limited and may be appropriately selected according to kinds of the toner and the carrier. To take the case of the resin-coated carrier (having density of 5 g/cm² to 8 g/cm²) as an example, it is preferable to use the toner in such an amount that the content of the toner in the two-component developer is 2% by weight to 30% by weight and preferably 2% by weight to 20% by weight, of a total amount of the two-component developer. Further, in the two-component developer, the coverage of the toner over the carrier is preferably 40% to 80%.

When the two-component developer of the invention contains the toner of the invention and the carrier, it is possible to obtain a two-component developer which takes into account preservation of the global environment and which is excellent in fixability and storage stability and moreover, good in light transmittance.

### [Image Forming Apparatus]

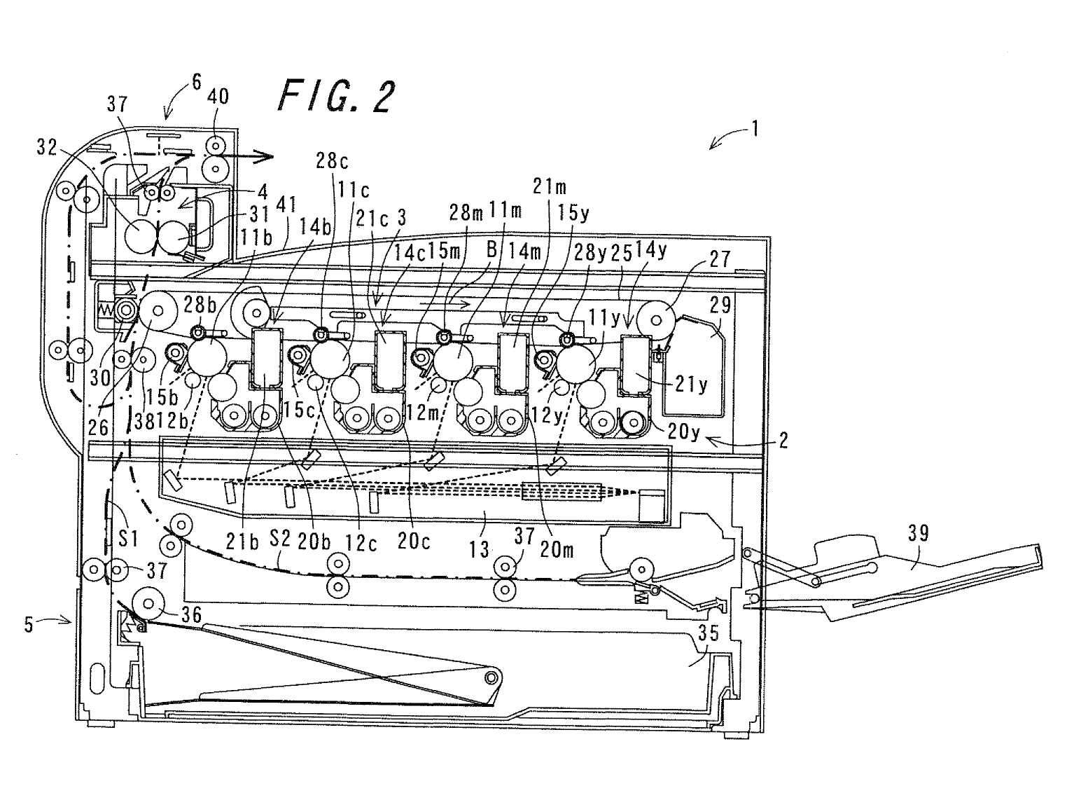

FIG. 2 is a cross-sectional view schematically showing an example of a configuration of an image forming apparatus 1 according to the invention. The image forming apparatus 1 is a multifunction printer having a copier function, a printer function, and a facsimile function together, and according to image information being conveyed to the image forming apparatus 1, a full-color or monochrome image is formed on a recording medium. That is, the image forming apparatus 1 has three types of print mode, i.e., a copier mode, a printer mode and a FAX mode, and the print mode is selected by a control unit (not shown) in accordance with, for example, the operation input from an operation portion (not shown) and reception of the printing job from external equipment such as a personal computer, a mobile device, an information recording storage medium, and a memory device. The image forming apparatus 1 includes a toner image forming section 2, a transferring section 3, a fixing section 4, a recording medium feeding section 5, and a discharging section 6. In accordance with image information of respective colors of black (b), cyan (c), magenta (m), and yellow (y) which are contained in color image information, there are provided respectively four sets of the components constituting the toner image forming section 2 and some parts of the components contained in the transferring section 3. The four sets of respective components provided for the respective colors are distinguished herein by giving alphabets indicating the respective colors to the end of the reference numerals, and in the case where the sets are collectively referred to, only the reference numerals are shown.

The toner image forming section 2 includes a photoreceptor drum 11, a charging section 12, an exposure unit 13, a developing device 14, and a cleaning unit 15. The charging section 12, the developing device 14, and the cleaning unit 13 are disposed around the photoreceptor drum 11 in the order just stated. The charging section 12 is disposed vertically below the developing device 14 and the cleaning unit 15.

The photoreceptor drum 11 is rotatably supported around an axis thereof by a driving section (not shown) and includes a conductive substrate (not shown) and a photosensitive layer (not shown) formed on a surface of the conductive substrate. The conductive substrate may be formed into various shapes such as a cylindrical shape, a circular columnar shape, and a thin film sheet shape. Among these shapes, the cylindrical shape is preferred. The conductive substrate is formed of a conductive material. As the conductive material, those customarily used in the relevant field can be used including, for example, metals such as aluminum, copper, brass, zinc, nickel, stainless steel, chromium, molybdenum, vanadium, indium, titanium, gold, and platinum; alloys formed of two or more of the metals; a conductive film in which a conductive layer containing one or two or more of aluminum, aluminum alloy, tin oxide, gold, indium oxide, etc. is formed on a film-like substrate such as a synthetic resin film, a metal film, and paper; and a resin composition containing at least conductive particles and/or conductive polymers. As the film-like substrate used for the conductive film, a synthetic resin film is preferred and a polyester film is particularly preferred. Further, as the method of forming the conductive layer in the conductive film, vapor deposition, coating, etc. are preferred.

The photosensitive layer is formed, for examples by stacking a charge generating layer containing a charge generating substance, and a charge transporting layer containing a charge transporting substance. In this case, an undercoat layer is preferably formed between the conductive substrate and the charge generating layer or the charge transporting layer. When the undercoat layer is provided, the flaws and irregularities present on the surface of the conductive substrate are covered, leading to advantages such that the photosensitive layer has a smooth surface, that chargeability of the photosensitive layer can he prevented from degrading during repetitive use, and that the charging property of the photosensitive layer can be enhanced under a low temperature circumstance and/or a low humidity circumstance. Further, the photosensitive layer may be a laminated photoreceptor having a highly-durable three-layer structure in which a photoreceptor surface-protecting layer is provided on the top layer.

The charge generating layer contains as a main ingredient a charge generating substance that generates charge under irradiation of light, and optionally contains known binder resin, plasticizer, sensitizer, etc. As the charge generating substance, materials used customarily in the relevant field can be used including, for example, perylene pigments such as perylene imide and perylenic acid anhydride; polycyclic quinone pigments such as quinacridone and anthraquinone; phthalocyanine pigments such as metal and non-metal phthalocyanines, and halogenated non-metal phthalocyanines; squalium dyes; azulenium dyes; thiapylirium dyes; and azo pigments having carbazole skeleton, styrylstilbene skeleton, triphenylamine skeleton, dibenzothiophene skeleton, oxadiazole skeleton, fluorenone skeleton, bisstilbene skeleton, distyryloxadiazole skeleton, or distyryl carbazole skeleton. Among those charge generating substances, non-metal phthalocyanine pigments, oxotitanyl phthalocyanine pigments, bisazo pigments containing fluorene rings and/or fluorenone rings, bisazo pigments containing aromatic amines, and trisazo pigments have high charge generating ability and are suitable for forming a highly-sensitive photosensitive layer. The charge generating substances may be used each alone, or two or more of them may be used in combination. The content of the charge generating substance is not particularly limited, and preferably from 5 parts by weight to 500 parts by weight and more preferably from 10 parts by weight to 100 parts by weight based on 100 parts by weight of the binder resin in the charge generating layer. Also as the binder resin for charge generating layer, materials used customarily in the relevant field can be used including, for example, melamine resin, epoxy resin, silicone resin, polyurethane, acrylic resin, vinyl chloride-vinyl acetate copolymer resin, polycarbonate, phenoxy resin, polyvinyl butyral, polyallylate, polyamide, and polyester. The binder resins may be used each alone or, optionally, two or more of them may be used in combination.

The charge generating layer can be formed by dissolving or dispersing an appropriate amount of a charge generating substance, a binder resin and, optionally, a plasticizer, a sensitizer, etc. respectively in an appropriate organic solvent in which the ingredients described above are dissolvable or dispersible, to thereby prepare a coating solution for charge generating layer, and then applying the coating solution for charge generating layer to the surface of the conductive substrate, followed by drying. The thickness of the charge generating layer obtained in this way is not particularly limited, and preferably from 0.05 μm to 5 μm and more preferably from 0.1 μm to 2.5 μm.

The charge transporting layer stacked over the charge generating layer contains as essential ingredients a charge transporting substance having an ability of receiving and transporting the charge generated from the charge generating substance, and a hinder resin for charge transporting layer, and optionally contains known antioxidant, plasticizer, sensitizer, lubricant, etc. As the charge transporting substance, materials used customarily in the relevant field can be used Including, for example: electron donating materials such as poly-N-vinyl carbazole, a derivative thereof, poly-γ-carbazolyl ethyl glutamate, a derivative thereof, a pyrene-formaldehyde condensation product, a derivative thereof, polyvinylpyrene, polyvinyl phenanthrene, an oxazole derivative, an oxadiazole derivative, an imidazole derivative, 9-(p-diethylaminostyryl)anthracene, 1,1-bis(4-dibenzylaminophenyl)propane, styrylanthracene, styrylpyrazoline, a pyrazoline derivative, phenyl hydrazones, a hydrazone derivative, a triphenylamine compound, a tetraphenyldiamine compound, a triphenylmethane compound, a stilbene compound, and an azine compound having 3-methyl-2-benzothiazoline ring; and electron accepting materials such as a fluorenone derivative, a dibenzothiophene derivative, an indenothiophene derivative, a phenanthrenequinone derivative, an indenopyridine derivative, a thioquisantone derivative, a benzo[c]cinnoline derivative, a phenazine oxide derivative, tetracyanoethylene, tetracyanoquinodimethane, bromanil, chloranil, and benzoquinone. The charge transporting substances may be used each alone, or two or more of them may be used in combination. The content of the charge transporting substance is not particularly limited, and preferably from 10 parts by weight to 300 parts by weight and more preferably from 30 parts by weight to 150 parts by weight based on 100 parts by weight of the binder resin in the charge transporting substance. As the binder resin for charge transporting layer, it is possible to use materials which are used customarily in the relevant field and capable of uniformly dispersing the charge transporting substance, including. For example, polycarbonate, polyallylate, polyvinylbutyral, polyamide, polyester, polyketone, an epoxy resin, polyurethane, polyvinylketone, polystyrene, polyacrylamide, a phenolic resin, a phenoxy resin, a polysulfone resin, and a copolymer resin thereof. Among those materials, in view of the film forming property, and the wear resistance, an electrical property etc. of the obtained charge transporting layer, it is preferable to use, for example, polycarbonate which contains bisphenol Z as the monomer ingredient (hereinafter referred to as “bisphenol Z polycarbonate”) and a mixture of bisphenol Z polycarbonate and other polycarbonate. The binder resins may be used each alone, or two or more of them may be used in combination.

The charge transporting layer preferably contains an antioxidant together with the charge transporting substance and the binder resin for charge transporting layer. Also for the antioxidant, materials used customarily in the relevant field can be used including, for example, Vitamin E, hydroquinone, hindered amine, hindered phenol, paraphenylene diamine, arylalkane, and derivatives thereof, an organic sulfur compound, and an organic phosphorus compound. The antioxidants may be used each alone, or two or more of them may be used in combination. The content of the antioxidant is not particularly limited, and is 0.01% by weight to 10% by weight and preferably 0.05% by weight to 5% by weight of the total amount of the ingredients constituting the charge transporting layer. The charge transporting layer can be formed by dissolving or dispersing an appropriate amount of a charge transporting substance, a binder resin and, optionally, an antioxidant, a plasticizer, a sensitizer, etc. respectively in an appropriate organic solvent which is capable of dissolving or dispersing the ingredients described above, to thereby prepare a coating solution for charge transporting layer, and applying the coating solution for charge transporting layer to the surface of a charge generating layer followed by drying. The thickness of the charge transporting layer obtained in this way is not particularly limited, and preferably 10 μm to 50 μm and more preferably 15 μm to 40 μm. Note that it is also possible to form a photosensitive layer in which a charge generating substance and a charge transporting substance are present in one layer. In this case, the kinds and contents of the charge generating substance and the charge transporting substance, the kind of the hinder resin, and other additives may be the same as those in the case of forming separately the charge generating layer and the charge transporting layer.

In the embodiment, there is used a photoreceptor drum which has an organic photosensitive layer as described above containing the charge generating substance and the charge transporting substance. It is, however, also possible to use, instead of the above photoreceptor drum, a photoreceptor drum which has an inorganic photosensitive layer containing silicon or the like.

The charging section 12 faces the photoreceptor drum 11 and is disposed away from the surface of the photoreceptor drum 11 when viewed in a longitudinal direction of the photoreceptor drum 11. The charging section 12 charges the surface of the photoreceptor drum 11 so that the surface of the photoreceptor drum 11 has predetermined polarity and potential. As the charging section 12, it is possible to use a charging brush type charging device, a charger type charging device, a pin array type charging device, an ion-generating device, etc. Although the charging section 12 is disposed away from the surface of the photoreceptor drum 11 in the embodiment, the configuration is not limited thereto. For example, a charging roller may be used as the charging section 12, and the charging roller may be disposed in pressure-contact with the photoreceptor drum 12. It is also possible to use a contact-charging type charger such as a charging brush or a magnetic brush.

The exposure unit 13 is disposed so that light beams corresponding to each color information emitted from the exposure unit 13 pass between the charging section 12 and the developing device 14 and reach the surface of the photoreceptor drum 11. In the exposure unit 13, the image information is converted into light beams corresponding to each color information of black (b), cyan (c), magenta (m), and yellow (y), and the surface of the photoreceptor drum 11 which has been evenly charged by the charging section 12, is exposed to the light beams corresponding to each color information to thereby form electrostatic latent images on the surfaces of the photoreceptor drums 11. As the exposure unit 13, it is possible to use a laser scanning unit having a laser-emitting portion and a plurality of reflecting mirrors. The other usable examples of the exposure unit 13 may include an LED array and a unit in which a liquid-crystal shutter and a light source are appropriately combined with each other.

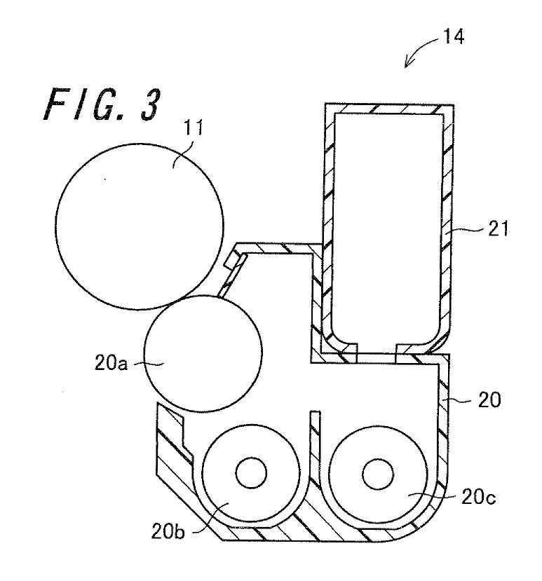

FIG. 3 is a cross-sectional view schematically showing an example of a configuration of a developing device 14 according to the invention. The developing device 14 includes a developing tank 20 and a toner hopper 21. The developing tank 20 is a container-shaped member which is disposed so as to face the surface of the photoreceptor drum 11 and used to supply a toner to an electrostatic latent image formed on the surface of the photoreceptor drum 11 so as to develop the electrostatic latent image into a visualized image, i.e. a toner image. The developing tank 20 contains in an internal space thereof the toner, and rotatably supports roller members such as a developing roller 20a, a supplying roller 20b, and an agitating roller 20c, or screw members, which roller or screw members are contained in the developing tank 20. The developing tank 20 has an opening in a side face thereof opposed to the photoreceptor drum 11. The developing roller 20a is rotatably provided at such a position as to face the photoreceptor drum 11 through the opening just stated. The developing roller 20a is a roller-shaped member for supplying a toner to the electrostatic latent image on the surface of the photoreceptor drum 11 in a pressure-contact portion or most-adjacent portion between the developing roller 20a and the photoreceptor drum 11. In supplying the toner, to a surface of the developing roller 20a is applied potential whose polarity is opposite to polarity of the potential of the charged toner, which serves as development bias voltage. By so doing, the toner on the surface of the developing roller 20a is smoothly supplied to the electrostatic latent image. Furthermore, an amount of the toner being supplied to the electrostatic latent image (which amount is referred to as “toner attachment amount”) can be controlled by changing a value of the development bias voltage. The supplying roller 20b is a roller-shaped member which is rotatably disposed so as to face the developing roller 20a and used to supply the toner to the vicinity of the developing roller 20a. The agitating roller 20c is a roller-shaped member which is rotatably disposed so as to face the supplying roller 20b and used to feed to the vicinity of the supplying roller 20b the toner which is newly supplied from the toner hopper 21 into the developing tank 20. The toner hopper 21 is disposed so as to communicate a toner replenishment port (not shown) formed in a vertically lower part of the toner hopper 21, with a toner reception port (not shown) formed in a vertically upper part of the developing tank 20. The toner hopper 21 replenishes the developing tank 20 with the toner according to toner consumption. Further, it may be possible to adopt such configuration that the developing tank 20 is replenished with the toner supplied directly from a toner cartridge of each color without using the toner hopper 21.

The cleaning unit 15 removes the toner which remains on the surface of the photoreceptor drum 11 after the toner image has been transferred to the recording medium, and thus cleans the surface of the photoreceptor drum 11. In the cleaning unit 15, a platy member is used such as a cleaning blade. In the image forming apparatus 1 of the invention, an organic photoreceptor drum is mainly used as the photoreceptor drum 11. A surface of the organic photoreceptor drum contains a resin component as a main ingredient and therefore tends to be degraded by chemical action of ozone which is generated by corona discharging of a charging device. The degraded surface part is, however, worn away by abrasion through the cleaning unit 15 and thus removed reliably, though gradually. Accordingly, the problem of the surface degradation caused by the ozone, etc. is actually solved, and the potential of charge given in the charging operation can be thus maintained stably for a long period of time. Although the cleaning unit 15 is provided in the embodiment, no limitation is imposed on the configuration and the cleaning unit 15 does not have to be provided.

In the toner image forming section 2, signal light corresponding to the image information is emitted from the exposure unit 13 to the surface of the photoreceptor drum 11 which has been evenly charged by the charging section 12, thereby forming an electrostatic latent image; the toner is then supplied from the developing device 14 to the electrostatic latent image, thereby forming a toner image; the toner image is transferred to an intermediate transfer belt 25; and the toner which remains on the surface of the photoreceptor drum 11 is removed by the cleaning unit 15. A series of the toner image forming operations just described is repeatedly carried out.

The transferring section 3 is disposed above the photoreceptor drum 11 and includes the intermediate transfer belt 25, a driving roller 26, a driven roller 27, intermediate transferring rollers 28(b, c, m, y), a transfer belt cleaning unit 29, and a transferring roller 30. The intermediate transfer belt 25 is an endless belt stretched between the driving roller 26 and the driven roller 27, thereby forming a loop-shaped travel path. The intermediate transfer belt 25 rotates in an arrow B direction.

When the intermediate transfer belt 25 passes by the photoreceptor drum 11 in contact therewith, the transfer bias voltage whose polarity is opposite to the polarity of the charged toner on the surface of the photoreceptor drum 11 is applied from the intermediate transferring roller 28 which is disposed opposite to the photoreceptor drum 11 across the intermediate transfer belt 25, with the result that the toner image formed on the surface of the photoreceptor drum 11 is transferred onto the intermediate transfer belt 25. In the case of a multicolor image, the toner images of respective colors formed on the respective photoreceptor drums 11 are sequentially transferred and overlaid onto the intermediate transfer belt 25, thus forming a multicolor toner image. The driving roller 26 can rotate around an axis thereof with the aid of a driving section (not shown), and the rotation of the driving roller 26 drives the intermediate transfer belt 25 to rotate in the arrow B direction. The driven roller 27 can be driven to rotate by the rotation of the driving roller 26, and imparts constant tension to the intermediate transfer belt 25 so that the intermediate transfer belt 25 does not go slack. The intermediate transferring roller 28 is disposed in pressure-contact with the photoreceptor drum 11 across the intermediate transfer belt 25, and capable of rotating around its own axis by a driving section (not shown). The intermediate transferring roller 28 is connected to a power source (not shown) for applying the transfer bias voltage as described above, and has a function of transferring the toner image formed on the surface of the photoreceptor drum 11 to the intermediate transfer belt 25. The transfer belt cleaning unit 29 is disposed opposite to the driven roller 27 across the intermediate transfer belt 25 so as to come into contact with an outer circumferential surface of the intermediate transfer belt 25. The residual toner which is attached to the intermediate transfer belt 25, which is caused by contact of the intermediate transfer belt 25 with the photoreceptor drum 11, may cause contamination on a reverse side of the recording medium, the transfer belt cleaning unit 29 removes and collects the toner on the surface of the intermediate transfer belt 25. The transferring roller 30 is disposed in pressure-contact with the driving roller 26 across the intermediate transfer belt 25, and capable of rotating around its own axis by a driving section (not shown). In a pressure-contact portion (a transfer nip portion) between the transferring roller 30 and the driving roller 26, a toner image which has been carried by the intermediate transfer belt 25 and thereby conveyed to the pressure-contact portion is transferred onto a recording medium fed from the later-described recording medium feeding section 5. The recording medium bearing the toner image is fed to the fixing section 4. In the transferring section 3, the toner image is transferred from the photoreceptor drum 11 onto the intermediate transfer belt 25 in the pressure-contact portion between the photoreceptor drum 11 and the intermediate transferring roller 28, and by the intermediate transfer belt 25 rotating in the arrow B direction, the transferred toner image is conveyed to the transfer nip portion where the toner image is transferred onto the recording medium.

The fixing section 4 is provided downstream of the transferring section 3 along a conveyance direction of the recording medium, and contains a fixing roller 31 and a pressure roller 32. The fixing roller 31 can rotate by a driving section (not shown), and heats the toner constituting an unfixed toner image borne on the recording medium so that the toner is fused to be fixed on the recording medium Inside the fixing roller 31 is provided a heating portion (not shown). The heating portion heats the heating roller 31 so that a surface of the heating roller 31 has a predetermined temperature (heating temperature). For the heating portion, a heater, a halogen lamp, and the like device can be used, for example. The heating portion is controlled by a fixing condition controlling portion. In the vicinity of the surface of the fixing roller 31 is provided a temperature detecting sensor which detects a surface temperature of the fixing roller 31. A result detected by the temperature detecting sensor is written to a memory portion of a control unit described later. The pressure roller 32 is disposed in pressure-contact with the fixing roller 31, and supported so as to be rotatably driven by the rotation of the fixing roller 31. The pressure roller 32 helps the toner image to be fixed onto the recording medium by pressing the toner and the recording medium when the toner is fused to be fixed on the recording medium by the fixing roller 31. A pressure-contact portion between the fixing roller 31 and the pressure roller 32 is a fixing nip portion. In the fixing section 4, the recording medium onto which the toner image has been transferred in the transfer section 3 is nipped by the fixing roller 31 and the pressure roller 32 so that when the recording medium passes through the fixing nip portion, the toner Image is pressed and thereby fixed onto the recording medium under heat, whereby an image is formed.

The recording medium feeding section 5 includes an automatic paper feed tray 35, a pickup roller 36, conveying rollers 37, registration rollers 38, and a manual paper feed tray 39. The automatic paper feed tray 35 is disposed in a vertically lower part of the image forming apparatus 1 and in form of a container-shaped member for storing the recording mediums. Examples of the recording medium include plain paper, color copy paper, sheets for overhead projector, and postcards. The pickup roller 36 takes out sheet by sheet the recording mediums stored in the automatic paper feed tray 35, and feeds the recording mediums to a paper conveyance path S1. The conveying rollers 37 are a pair of roller members disposed in pressure-contact with each other, and convey the recording medium to the registration rollers 38. The registration rollers 38 are a pair of roller members disposed in pressure-contact with each other, and feed to the transfer nip portion the recording medium fed from the conveying rollers 37 in synchronization with the conveyance of the toner image borne on the intermediate transfer belt 25 to the transfer nip portion. The manual paper feed tray 39 is a device storing recording mediums which are different from the recording mediums stored in the automatic paper feed tray 35 and may have any size and which are to be taken into the image forming apparatus 1, and the recording medium taken in from the manual paper feed tray 39 passes through a paper conveyance path S2 by use of the conveying rollers 37, thereby being fed to the registration rollers 38. In the recording medium feeding section 5, the recording medium supplied sheet by sheet from the automatic paper feed tray 35 or the manual paper feed tray 39 is fed to the transfer nip portion in synchronization with the conveyance of the toner image borne on the intermediate transfer belt 25 to the transfer nip portion.

The discharging section 6 includes the conveying rollers 37, discharging rollers 40, and a catch tray 41. The conveying rollers 37 are disposed downstream of the fixing nip portion along the paper conveyance direction, and convey toward the discharging rollers 40 the recording medium onto which the image has been fixed by the fixing section 4. The discharging rollers 40 discharge the recording medium onto which the image has been fixed, to the catch tray 41 disposed on a vertically upper surface of the image forming apparatus 1. The catch tray 41 stores the recording medium onto which the image has been fixed.

The image forming apparatus 1 includes a control unit (not shown). The control unit is disposed, for example, in an upper part of an internal space of the image forming apparatus, and contains a memory portion, a computing portion, and a control portion. To the memory portion of the control unit are input, for example, various set values obtained by way of an operation panel (not shown) disposed on the upper surface of the image forming apparatus, results detected from a sensor (not shown) etc. disposed in various portions inside the image forming apparatus, and Image information obtained from external equipment. Further, programs for operating various functional elements are written. Examples of the various functional elements include a recording medium determining portion, an attachment amount controlling portion, and a fixing condition controlling portion. For the memory portion, those customarily used in the relevant filed can be used including, for example, a read only memory (ROM), a random access memory (RAM), and a hard disc drive (HDD). For the external equipment, it is possible to use electrical and electronic devices which can form or obtain the image information and which can be electrically connected to the image forming apparatus. Examples of the external equipment include a computer, a digital camera, a television, a video recorder, a DVD (digital versatile disc) recorder, an HDDVD (high-definition digital versatile disc), a blu-ray disc recorder, a facsimile machine, and a mobile computer. The computing portion of the control unit takes out the various data (such as an image formation order, the detected result, and the image information) written in the memory portion and the programs for various functional elements, and then makes various determinations. The control portion of the control unit sends to a relevant device a control signal in accordance with the result determined by the computing portion, thus performing control on operations. The control portion and the computing portion include a processing circuit which is achieved by a microcomputer, a microprocessor, etc. having a central processing unit (abbreviated as CPU). The control unit contains a main power source as well as the above-stated processing circuit. The power source supplies electricity to not only the control unit but also respective devices provided inside the image forming apparatus.

In this way, in the developing device 14 of the invention, when the development is carried out using the toner or two-component developer of the invention, it is possible to maintain storage stability while ensuring fixability of the toner. Hence, it is possible to maintain stable performance against a stress such as stirring within the developing tank.

Also, in the image forming apparatus 1 of the invention, when it is provided with the developing device 14 of the invention, it is possible to form a stable image with high image quality which is excellent in fixability and color forming properties without generating a trouble over a long period of time.

Also, it is preferable that the image forming apparatus 1 of the invention is provided with the fixing section 4 for heat melting a toner image formed on a recording medium and fixing it. In this way, by forming a fixed image using the toner of the invention by the image forming apparatus 1 provided with the foregoing fixing section 4, it is possible to obtain an image with high image quality which effectively brings out physical properties of the toner having both low-temperature fixability and storage stability.

### EXAMPLES

The invention is hereunder specifically described with reference to the following examples and comparative examples, but it should not be construed that the invention is not limited to, in particular, these examples so far as the gist of the invention is not deviated.

### [Measurement Methods of Physical Properties]

Respective physical properties in the examples and comparative examples were measured in the following manners.

### [Glass Transition Temperature (Tg) of Binder Resin]

Using a differential scanning calorimeter (a trade name: DIAMOND DSC, manufactured by PerkinElmer Japan Co., Ltd.), 0.01 g of a sample was heated at a temperature rise rate of 10° C. per minute (10° C./min) in conformity with Japan Industrial Standards (JIS) K7121-1987, thereby measuring a DSC curve. A temperature at an intersection between an extended straight line obtained by drawing a base line on a low-temperature side of an exothermic peak corresponding to glass transition of the obtained DSC curve toward a high-temperature side and a tangent line drawn at a point where a gradient became the maximum against the curve on the low-temperature side of the peak was determined as a glass transition temperature (Tg).

### [Softening Temperature (T_{1/2})]

Using a rheological properties evaluation system (a trade name: FLOW TESTER CFT-500C, manufactured by Shimadzu Corporation), 1 g of a sample was inserted into a cylinder, heated at a temperature rise rate of 6° C. per minute (6° C./min) while applying a load of 10 kgf/cm² (0.98 MPa) such that it was extruded from a die, and a temperature at which a half of the sample flowed out from the die was determined as a softening temperature. As the die, one having an aperture of 1 mm and a length of 1 mm was used.

### [Peak Top Molecular Weight, Weight Average Molecular Weight (Mw) and Molecular Weight Distribution Index (Mw/Mn)]

Using a GPC analyzer (a trade name: HLC-8220GPC, manufactured by Tosoh Corporation), a tetrahydrofuran (hereinafter referred to as “THF”) solution of 0.25% by weight of a sample was used as a sample solution at 40° C., an injection amount of the sample solution was set up at 200 μL, and a molecular weight distribution curve was determined. A molecular weight at a top of a peak of the obtained molecular weight distribution curve was determined as a peak top molecular weight. Also, a weight average molecular weight Mw and a number average molecular weight Mn were determined from the obtained molecular weight distribution curve, and a molecular weight distribution index (Mw/Mn; hereinafter referred to simply as “Mw/Mn”) which is a ratio of the weight average molecular weight Mw to the number average molecular weight Mn was determined. A molecular weight calibration curve was prepared using standard polystyrene.

### [Acid Number]

An acid number was measured by the neutralization titration method as follows. That is, 5 g of a sample was dissolved in 50 ml of THF, and after adding a few of drops of an ethanol solution of phenolphthalein as an indicator, the solution was titrated with 0.1 moles/L of a potassium hydroxide (KOH) aqueous solution. A point at which a color of the sample solution changed from colorless to purple was defined as en end point, and an acid number (mg-KOH/g) was calculated from the amount of the potassium hydroxide aqueous solution required for the arrival at the end point and a weight of the sample provided for the titration.

### [THF-Insoluble Matter of Binder Resin]

1 g of a sample was charged in cylindrical filter paper, applied to a Soxhlet extractor and then refluxed for 6 hours upon heating using 100 mL of THF as a solvent, thereby extracting a THF-soluble component in the sample with THF. After removing the solvent from an extract containing the extracted THF-soluble matter, the THF-soluble matter was dried at 100° C. for 24 hours, and a weight X (g) of the obtained THF-soluble matter was weighed. A proportion P (% by weight) of a THF-insoluble matter which is a component insoluble in THF in the binder resin was calculated from the determined weight X (g) of the THF-soluble matter and the weight (1 g) of the sample used for the measurement on the basis of the following expression (2). This proportion P is hereinafter referred to as “THF-insoluble matter”.

P (% by weight)={1 (g)−X (g)}/1 (g)×100 (2)

### [Melting Point (Tm)]

Using a differential scanning calorimeter (a trade name: DIAMOND DSC, manufactured by PerkinElmer Japan Co., Ltd.), the temperature of 0.01 g of a sample was raised from 20° C. to 200° C. at a rate of 10° C. per minute, subsequently dropped from 200° C. to 20° C. at a rate of 50° C. per minute and then again raised from 20° C. to 200° C. at a rate of 10° C. per minute in conformity with Japan Industrial Standards (JIS) K7121-1987. With respect to a peak of heat of fusion of the thus obtained DSC curve, a temperature of a top of the peak was determined as a melting point (Tm).

### [Viscoelasticity of Toner]

A storage modulus G′ and a loss modulus G″ were measured using parallel plates by a stress rheometer (manufactured by Reologica Instruments AB) as follows. That is, 0.6 g of a sample was pressed at room temperature (25° C.) under about 20 MPa for one minute by a tableting machine, thereby preparing a sample for measurement having a thickness of about 0.5 mm and a diameter of 25 mm. This sample for measurement was nipped by parallel plates having a diameter of 25 mm and heated for melting; a gap between the parallel plates was then set up at 1.0 mm; a strain sinusoidally vibrating in a circumferential direction of the parallel plates was given under a condition at a strain of 5% and a frequency of 1.0 Hz, thereby subjecting the sample for measurement to sinusoidal vibration; the temperature was raised from 80° C. to 200° C. at a temperature rise rate of 3° C./min; and a storage modulus G′ and a loss modulus G″ at each temperature at intervals of the measurement temperature of 10° C. were measured. Then, a loss modulus-temperature characteristic curve which expresses the relationship between the loss modulus G″ and the temperature and a loss tangent-temperature characteristic curve which expresses the relationship between the loss tangent (tan δ, G″/G′) and the temperature were determined from the obtained measurement results, and values of the loss modulus G″ at 120° C. and 200° C. and the loss tangent (tan δ) were determined from these graphs.

### [Particle Size Distribution (Volume Average Particle Size (D_{50V}) and Coefficient of Vibration (CV Value) of Toner)

20 mg of a sample and 1 mL of an alkyl ether sulfuric acid ester sodium (a dispersant, manufactured by Kishida Chemical Co., Ltd.) were added to 50 mL of an electrolytic solution (a trade name: ISOTON-II, manufactured by Beckman Coulter, Inc.), and the mixture was subjected to an ultrasonic dispersion treatment at an ultrasonic frequency of 20 kHz for 3 minutes by an ultrasonic disperser (a trade name: UH-50, manufactured by SMT Co., Ltd.), thereby preparing a sample for measurement. With respect to this sample for measurement, the particle size of the sample particles was measured under a condition at an aperture size of 20 μm and the number of measured particles of 50,000 counts by using a particle size distribution analyzer (a trade name: MULTISIZER 3, manufactured by Beckman Coulter, Inc.). Volume particle size distribution of the sample particles was determined from the obtained measurement result, and a volume average particle size D_{50V} (μm) was calculated from the obtained volume particle size distribution. Also, a standard deviation in the volume particle size distribution was determined, and a coefficient of variation (CV value, %) was calculated on the basis of the following expression (3). The “volume average particle size D_{50V} (μm)” as referred to herein refers to a particle size at which a cumulative volume from the side of a large particle size in the cumulative volume distribution becomes 50%.

CV value (%)={(Standard deviation in volume particle size distribution)/(Volume average particle size) (μm)}×100 (3)

### Example 1

### [Premixing Step]

A toner raw material containing 81.5% by weight (90.0 parts by weight) of a polyester resin A (glass transition temperature (Tg): 60° C., softening temperature (T_{1/2}): 110° C., peak top molecular weight: 12,500, Mw/Mn=5.2, acid number: 16, THF-insoluble matter: 0%) which is a major component and 9.0% by weight (10.0 parts by weight) of a polylactic acid resin A (a trade name: TERRAMAC TE-2000C, manufactured by Unitika, Ltd., melting point (Tm): 170° C.) as a binder resin (100 parts by weight); 5.0% by weight (5.5 parts by weight) of KET. BLUE 111 (a trade name: copper phthalocyanine 15:3, manufactured by Clariant Ltd.) as a colorant; 3.0% by weight (3.3 parts by weight) of a paraffin wax (a trade name; HNP-10, manufactured by Nippon Seiro Co., Ltd., melting point (Tm): 75° C.) as a release agent; and 1.5% by weight (1.7 parts by weight) of a charge control agent (a trade name: COPY CHARGE N4P VP 2481, manufactured by Clariant (Japan) K.K.) was mixed for 3 minutes in a Henschel mixer (a trade name: FM20C, manufactured by Mitsui Mining Co., Ltd.), thereby obtaining a mixture.

### [Melt-Kneading Step]

20.0 kg of the mixture was melt-kneaded in an open roller type (two-roller type) continuous kneading machine (a trade name: MOS 320-1800, manufactured by Mitsui Mining Co., Ltd.), thereby preparing a melt-kneaded material. At that time, the setting condition of the open rollers was 140° C. for a temperature on a supplying side of a heating roller and 70° C. for a temperature on a discharge side thereof; and 80° C. for a temperature on a supplying side of a cooling roller and 15° C. for a temperature on a discharge side thereof. A roller having a diameter of 320 mm and an effective length of 1,550 mm was used as each of the heating roller and the cooling rollers, and a gap between the rollers on each of the supplying side and the discharge side was set up at 0.3 mm. A rotation rate of the heating roller was set up at 75 rpm; a rotation rate of the cooling roller was set up at 65 rpm; and a supplying amount of the mixture was set up at 30 kg/h.

### [Pulverization and Classification Step]

The melt-kneaded material obtained in the melt-kneading step was cooled for solidification to room temperature and then coarsely pulverized by a cutter mill la trade name: VM-16, manufactured by Orient Co., Ltd.). Subsequently, the coarsely pulverized material obtained by coarse pulverization was finely pulverized by a counter jet mill (a trade name: AFG, manufactured by Hosokawa Micron Corporation), and the obtained pulverized material was then classified by a rotary type classifier (a trade name: TSP SEPARATOR, manufactured by Hosokawa Micron Corporation), thereby removing an excessively-pulverized toner particle. There was thus obtained a toner particle.

The obtained toner particle had a value of a loss modulus G″ at 120° C. of 5.4 ×10⁴ Pa, a value of a loss modulus G″ at 200° C. of 2.5×10² Pa and a value of a loss tangent (tan δ) at 200° C. of 4.1. Also, a temperature at which the loss modulus G″ of the toner particle at a frequency of 1 Hz was 10³ Pa was 160° C., and the melting point (Tm) of the polylactic acid resin A was higher by a temperature of 10° C. than the former.

Subsequently, 0.2 parts by weight of hydrophobic silica (a trade name, R-974, manufactured by Nippon Aerosil Co., Ltd., and 0.3 parts by weight of hydrophobic titanium (a trade name: T-805, manufactured by Nippon Aerosil Co., Ltd.) were added to 100 parts by weight of the obtained toner particle and mixed in a Henschel mixer (a trade name: FM MIXER, manufactured by Mitsui Mining Co., Ltd.), thereby manufacturing 16.8 kg of a toner of Example 1.

The obtained toner had a volume average particle size of 6.7 μm and a coefficient of variation (CV value) of 23%.

### Example 2

16.0 kg of a toner of Example 2 was manufactured in the same manner as in Example 1, except for using 72.4% by weight (80.0 parts by weight) of the polyester resin A which is a major component and 18.1% by weight (20.0 parts by weight) of the polylactic acid A as the binder resin (100 parts by weight) in the premixing step.

The obtained toner particle had a value of a loss modulus G″ at 120° C. of 7.8×10⁴ Pa, a value of a loss modulus G″ at 200° C. of 3.2×10² Pa and a value of a loss tangent (tan δ) at 200° C. of 3.2. Also, a temperature at which the loss modulus G″ of the toner particle at a frequency of 1 Hz was 10³ Pa was 164° C., and the melting point (Tm) of the polylactic acid resin A was higher by a temperature of 6° C. than the former. Furthermore, the obtained toner had a volume average particle size of 6.8 μm and a coefficient of variation (CV value) of 25%.

### Example 3

### [Manufacture of Polylactic Acid Resin B]

47.5 kg of L-lactide and 2.5 kg of D-lactide were charged in a polymerization reaction tank and uniformly mixed upon heat melting while stirring in a nitrogen atmosphere. Subsequently, after adding 15 g of tin octylate, the mixture was heated at 190° C. and subjected to ring opening polymerization upon heating for 3 hours until a viscosity of the reactant had become high. There was thus manufactured a polylactic acid resin B (weight average molecular weight (Mw): 12,000, Mw/Mn=2.7, meeting point (Tm): 129° C., molar ratio of D-lactic acid unit to L-lactic acid unit: 0.085).

### [Manufacture of Toner]

14.1 kg of a toner of Example 3 was manufactured in the same manner as in Example 1, except for using 54.3% by weight (60.0 parts by weight) of the polyester resin A which is a major component and 36.2% by weight (40.0 parts by weight) of the polylactic acid B as the binder resin (100 parts by weight) in the premixing step.

The obtained toner particle had a value of a loss modulus G″ at 120° C. of 4.3×10⁴ Pa, a value of a loss modulus G″ at 200° C. of 7.8×10 Pa and a value of a loss tangent (tan δ) at 200° C. of 6.5. Also, a temperature at which the loss modulus G″ of the toner particle at a frequency of 1 Hz was 10³ Pa was 120° C., and the melting point (Tm) of the polylactic acid resin B was higher by a temperature of 9° C. than the former. Furthermore, the obtained toner had a volume average particle size of 6.7 μm and a coefficient of variation (CV value) of 24%.

### Example 4

### [Manufacture of Polylactic Acid Resin C]

A polylactic acid resin C (weight average molecular weight (Mw): 11,000, Mw/Mn=2.8, melting point (Tm): 123° C., molar ratio of D-lactic acid unit to L-lactic acid unit: 0.2) was manufactured in the same manner as in the polylactic acid resin B, except for changing the charging amounts of L-lactide and D-lactide to 40 kg and 10 kg, respectively.

### [Manufacture of Toner]

15.3 kg of a toner of Example 4 was manufactured in the same manner as in Example 1, except for using 49.8% by weight (55.0 parts by weight) of the polyester resin A which is a major component and 40.7% by weight (45.0 parts by weight) of the polylactic acid C as the binder resin (100 parts by weight) in the premixing step.

The obtained toner particle had a value of a loss modulus G″ at 120° C. of 3.2×10⁴ Pa, a value of a loss modulus G″ at 200° C. of 5.1×10 Pa and a value of a loss tangent (tan δ) at 200° C. of 7.2. Also, a temperature at which the loss modulus G″ of the toner particle at a frequency of 1 Hz was 10³ Pa was 114° C., and the melting point (Tm) of the polylactic acid resin C was higher by a temperature of 9° C. than the former. Furthermore, the obtained toner had a volume average particle size of 6.5 μm and a coefficient of variation (CV value) of 23%.

### Comparative Example 1

The manufacture of a toner was tried in the same manner as in Example 1, except for using 36.2% by weight (40.0 parts by weight) of the polyester resin A which is a major component and 54.3% by weight (60.0 parts by weight) of the polylactic acid A as the binder resin (100 parts by weight) in the premixing step. However, melt-kneading could not be achieved, and a toner of Comparative Example 1 could not be obtained.

### Comparative Example 2

15.1 kg of a toner of Comparative Example 2 was manufactured in the same manner as in Example 2, except for melt-kneading the mixture using an extruder (a trade name: PCM-30, manufactured by Ikegai, Ltd.) in the melt-kneading step. At that time, as to the setting condition of the extruder, the number of rotation of the screw was set up at 250 rpm, and the discharge amount was set up at 65 kg/h.

The obtained toner particle had a value of a loss modulus G″ at 120° C. of 5.2×10⁴ Pa, a value of a loss modulus G″ at 200° C. of 7.3×10 Pa and a value of a loss tangent (tan δ) at 200° C. of 22. Also, a temperature at which the loss modulus G″ of the toner particle at a frequency of 1 Hz was 10³ Pa was 145° C., and the melting point (Tm) of the polylactic acid resin A was higher by a temperature of 25° C. than the former. Furthermore, the obtained toner had a volume average particle size of 8.8 μm and a coefficient of variation (CV value) of 41%.

### Comparative Example 3

13.2 kg of a toner of Comparative Example 3 was manufactured in the same manner as in Example 3, except for melt-kneading the mixture using an extruder (a trade name: PCM-30, manufactured by Ikegai, Ltd.) in the melt-kneading step. At that time, as to the setting condition of the extruder, the number of rotation of the screw was set up at 250 rpm, and the discharge amount was set up at 65 kg/h.

The obtained toner particle had a value of a loss modulus G″ at 120° C. of 4.7×10⁴ Pa, a value of a loss modulus G″ at 200° C. of 3.7×10 Pa and a value of a loss tangent (tan δ) at 200° C. of 15. Also, a temperature at which the loss modulus G″ of the toner particle at a frequency of 1 Hz was 10³ Pa was 116° C., and the melting point (Tm) of the polylactic acid resin B was higher by a temperature of 13° C. than the former. Furthermore, the obtained toner had a volume average particle size of 7.0 μm and a coefficient of variation (CV value) of 31%.

### Comparative Example 4

15.5 kg of a toner of Comparative Example 4 was manufactured in the same manner as in Example 4, except for melt-kneading the mixture using an extruder (a trade name: PCM-30, manufactured by Ikegai, Ltd.) in the melt-kneading step. At that time, as to the setting condition of the extruder, the number of rotation of the screw was set up at 250 rpm, and the discharge amount was set up at 65 kg/h.

The obtained toner particle had a value of a loss modulus G″ at 120° C. of 4.3 ×10⁴ Pa, a value of a loss modulus G″ at 200° C. of 8.7 Pa and a value of a loss tangent (tan δ) at 200° C. of 18. Also, a temperature at which the loss modulus G″ of the toner particle at a frequency of 1 Hz was 10³ Pa was 108° C., and the melting point (Tm) of the polylactic acid resin C was higher by a temperature of 15° C. than the former. Furthermore, the obtained toner had a volume average particle size of 6.8 μm and a coefficient of variation (CV value) of 33%.

### Comparative Example 5

12.1 kg of a toner of Comparative Example 5 was manufactured in the same manner as in Example 1, except For using a polyester resin B (glass transition temperature (Tg): 58° C., softening temperature (T_{1/2}): 102° C., peak top molecular weight: 8,500, Mw/Mn=2.5, acid number: 13, THF-insoluble matter: 0%) in place of the polyester resin A which is a major component as the binder resin (100 parts by weight) in the premixing step.

The obtained toner particle had a value of a loss modulus G″ at 120° C. of 4.5×10⁴ Pa, a value of a loss modulus G″ at 200° C. of 9.4 Pa and a value of a loss tangent (tan δ) at 200° C. of 35.2. Also, a temperature at which the loss modulus G″ of the toner particle at a frequency of 1 Hz was 10³ Pa was 140° C., and the melting point (Tm) of the polylactic acid resin A was higher by a temperature of 30° C. than the former. Furthermore, the obtained toner had a volume average particle size of 6.4 μm and a coefficient of variation (CV value) of 32%.

### Comparative Example 6

10.5 kg of a toner of Comparative Example 6 was manufactured in the same manner as in Example 1, except for using a polyester resin C (glass transition temperature (Tg): 60° C., softening temperature (T_{1/2}): 116° C., peak top molecular weight: 32,100, Mw/Mn=8.2, acid number: 9, THF-insoluble matter: 4%) in place of the polyester resin A which is a major component as the binder resin (100 parts by weight) in the premixing step.

The obtained toner particle had a value of a loss modulus G″ at 120° C. of 7.2 ×10⁵ Pa, a value of a loss modulus G″ at 200° C. of 1.1×10³ Pa and a value of a loss tangent (tan δ) at 200° C. of 1.2. Also, a temperature at which the loss modulus G″ of the toner particle at a frequency of 1 Hz was 10³ Pa was 170° C., which is the same temperature as the melting point (Tm) of the polylactic acid resin A. Furthermore, the obtained toner had a volume average particle size of 6.7 μm and a coefficient of variation (CV value) of 24%.

### Comparative Example 7

14.2 kg of a toner of Comparative Example 7 was manufactured in the same manner as in Example 1, except for using a styrene-acrylic resin D (glass transition temperature (Tg): 62° C., softening temperature (T_{1/2}): 127° C., peak top molecular weight: 12,000, acid number: 10.2, THF-insoluble matter: 7%) in place of the polyester resin A which is a major component as the binder resin (100 parts by weight) in the premixing step.

The obtained toner particle had a value of a loss modulus G″ at 120° C. of 4.3×10⁴ Pa, a value of a loss modulus G″ at 200° C. of 7.8×10 Pa and a value of a loss tangent (tan δ) at 200° C. of 12. Also, a temperature at which the loss modulus G″ of the toner particle at a frequency of 1 Hz was 10³ Pa was 126° C., and the melting point (Tm) of the polylactic acid resin A was higher by a temperature of 44° C. than the former. Furthermore, the obtained toner had a volume average particle size of 6.7 μm and a coefficient of variation (CV value) of 3.3%.

### Comparative Example 8

13.2 kg of a toner of Comparative Example 8 was manufactured in the same manner as in Example 1, except for using 83.3% by weight (92.0 parts by weight) of the polyester resin C in place of the polyester resin A which is a major component and 7.2% by weight (8.0 parts by weight) of the polylactic acid resin A as the binder resin (100 parts by weight) in the premixing step.

The obtained toner particle had a value of a loss modulus G″ at 120° C. of 5.9×10⁵ Pa, a value of a loss modulus G″ at 200° C. of 9.7×10⁴ Pa and a value of a loss tangent (tan δ) at 200° C. of 3.1. Also, a temperature at which the loss modulus G″ of the toner particle at a frequency of 1 Hz was 10³ Pa was 168° C., and the melting point (Tm) of the polylactic acid resin C was higher by a temperature of 2° C. than the former. Furthermore, the obtained toner had a volume average particle size of 6.8 μm and a coefficient of variation (CV value) of 23%.

With respect to the toners of Examples 1 to 4 and Comparative Examples 1 to 8, a kind of the resin which is a major component (referred to as “major component resin” in Table 1); kind, content and melting point (Tm) of the polylactic acid which is a crystalline resin; a value of a difference between a melting point (Tm) of the polylactic acid resin and a temperature at which a loss modulus G″ of the toner particle at a frequency of 1 Hz is 10³ Pa (referred to as “temperature” in Table 1) (the difference being referred to as “Tm—Temperature” in Table 1); viscoelasticity of the toner particle; and particle size distribution of the toner are shown in Table 1.

TABLE 1

| | Major | Crystaline resin | | | | | | | | Particle size | |
|---|---|---|---|---|---|---|---|---|---|---|---|
| | component | | Content | | Tm—Temperature | | Viscoelasticity | | | distribution | |
| | resin | | (parts by | Tm | Temperature | | G″ | G″ | | D_{50V} | CV value |
| | Kind | Kind | weight) | (° C.) | (° C.) | Difference | (at 120° C.) | (at 200° C.) | tan δ | (μm) | (%) |
| Example 1 | A | A | 10.0 | 170 | 160 | 10 | 5.4 × 10⁴ | 2.5 × 10² | 4.1 | 6.7 | 23 |
| Example 2 | A | A | 20.0 | 170 | 164 | 6 | 7.8 × 10⁴ | 3.2 × 10² | 3.2 | 6.8 | 25 |
| Example 3 | A | B | 40.0 | 129 | 120 | 9 | 4.3 × 10⁴ | 7.8 × 10 | 6.5 | 6.7 | 24 |
| Example 4 | A | C | 45.0 | 123 | 114 | 9 | 3.2 × 10⁴ | 5.1 × 10 | 7.2 | 6.5 | 23 |
| Comparative | A | A | 60.0 | 170 | — | — | — | — | — | — | — |
| Example 1 | | | | | | | | | | | |
| Comparative | A | A | 20.0 | 170 | 145 | 25 | 5.2 × 10⁴ | 7.3 × 10 | 22 | 8.8 | 41 |
| Example 2 | | | | | | | | | | | |
| Comparative | A | B | 40.0 | 129 | 116 | 13 | 4.7 × 10⁴ | 3.7 × 10 | 15 | 7.0 | 31 |
| Example 3 | | | | | | | | | | | |
| Comparative | A | C | 45.0 | 123 | 108 | 15 | 4.3 × 10⁴ | 8.7 | 18 | 6.8 | 33 |
| Example 4 | | | | | | | | | | | |
| Comparative | B | A | 10.0 | 170 | 140 | 30 | 4.5 × 10⁴ | 9.4 | 35.2 | 6.4 | 32 |
| Example 5 | | | | | | | | | | | |
| Comparative | C | A | 10.0 | 170 | 170 | 0 | 7.2 × 10⁵ | 1.1 × 10³ | 1.2 | 6.7 | 24 |
| Example 6 | | | | | | | | | | | |
| Comparative | D | A | 10.0 | 170 | 126 | 44 | 4.3 × 10⁴ | 7.8 × 10 | 12 | 6.7 | 3.3 |
| Example 7 | | | | | | | | | | | |
| Comparative | C | A | 8.0 | 170 | 168 | 2 | 5.9 × 10⁵ | 9.7 × 10⁴ | 3.1 | 6.8 | 23 |
| Example 8 | | | | | | | | | | | |

### [Evaluation]

With respect to the toners of Examples 1 to 4 and Comparative Examples 1 to 8, storage stability, fixability, fixing strength and light transmittance were evaluated in the following manners.

### [Storage Stability]

A toner was charged in each of three 50-mL plastic bottles in an amount of from 28 g to 30 g per bottle; each of the bottles was placed in a thermo-hydrostat set up at 50° C. and 10% RH in a state that the plastic bottle was capped; the bottle was taken out one by one at intervals of 24 hours; and an apparent density of the toner was measured using an apparent density analyzer (manufactured by Tsutsui Rikagaku Kikai Co., Ltd.) in conformity with JIS K-5101-12-1. The apparent density was measured at the initial stage and after elapsing 24 hours, 48 hours and 72 hours, respectively, and a degree of variation was calculated on the basis of the following expression (4). It is meant that the smaller the value of the degree of variation, the better the storage stability.

(Degree of variation)=(Apparent density after elapsing 72 hours)/(Apparent density at the initial stage)×100 (4)

Evaluation criteria of the storage stability are shown below.

Good: The degree of variation is 90% or more.

Not bad: The degree of variation is 80% or more and less than 90%.

Poor: The degree of variation is less than 80%.

### [Fixability]

Using a ferrite core carrier having a volume average particle size of 45 μm as a carrier, each of the toners of Examples 1 to 4 and Comparative Examples 1 to 8 was mixed for 20 minutes by a V-type mixer (a trade name: V-5, manufactured by Tokuju Corporation) so as to have a coverage of 60% relative to the carrier. There was thus prepared a two-component developer.

Using a modified color multifunction machine (a trade name: MX-2700, manufactured by Sharp Corporation), the obtained two-component developer was attached onto recording paper (a trade name: PPC PAPER SF-4AM3, manufactured by Sharp Corporation) which is a recording medium by regulating a sample image including a solid image part in a rectangular shape of 20 mm in length and 50 mm in width such that an attachment amount of the toner in an unfixed state in the solid image part was 0.5 mg/cm² relative to the recording paper, thereby preparing an unfixed image. A non-offset region of the obtained unfixed image was evaluated using an external fixer which had been prepared using the fixing part of the color multifunction machine. A fixing process rate was set up at 124 mm/sec, the temperature of a fixing roller was raised at intervals of 10° C. from 130° C., and a temperature region where neither low-temperature offset nor hot offset does not take place was defined as a non-offset region and determined as an index of fixability.

The matter that after the fixing roller has made a round in the state that the toner attaches onto the fixing roller without being fixed onto the recording paper at the time of fixing, the toner attaches onto the recording paper is defined with respect to the high-temperature and low-temperature offset. Evaluation criteria of the fixability are shown below.

Good: The temperature of the non-offset region is 5° C. or higher.

Not bad: The temperature of the non-offset region is 30° C. or higher and lower than 50° C.

Poor: The temperature of the non-offset region is lower than 30° C.

### [Fixing Strength]

A fixed image having been fixed at a temperature of 30° C. lower than a temperature at which the loss modulus G″ of the toner at a frequency of 1 Hz was 10³ Pa was prepared in the same operations as in the evaluation of the fixability. A mending tape (Model No.: No. 810-3-12, manufactured by Sumitomo 3M Limited) was lightly stuck onto the obtained fixed image; a weight of 837 g in a cylindrical shape (outer diameter: 75 mm, height: 50 mm) was rolled three times on the mending tape, thereby rubbing the mending tape against the fixed image; and the mending tape was then peeled away. An optical density of the fixed image was measured before sticking the mending tape and peeling away the mending tape using a spectrodensitometer (a trade name: X-Rite 938, manufactured by X-Rite, Incorporated), thereby evaluating the fixing strength.

A value of {(optical density of fixed image after peeling away the tape)/(optical density of fixed image before sticking the tap)×100} which is a value expressing a ratio of the optical density of the fixed image after peeling away the mending tape to the optical density of the fixed image before sticking the mending tap was defined as a ratio of fixing strength. It is meant that the larger the value of the ratio of fixing strength, the better the fixing strength and the broader the fixable temperature width.

Evaluation criteria of the fixing strength are shown below.

Good: The ratio of fixing strength is 80% or more.

Poor: The ratio of fixing strength is less than 80%.

### [Light Transmittance]

A two-component developer was prepared in the same operations as in the evaluation of the fixability. Using a modified color multifunction machine (a trade name: MX-2700, manufactured by Sharp Corporation), an unfixed image of a sample image was prepared on an OHP sheet by regulating an attachment amount of the toner at 1.7 mg/cm², thereby preparing a fixed image. A HAZE value of the obtained fixed image was measured using a HAZE meter, Model NDH2000 (a trade name, manufactured by Nippon Denshoku Industries Co., Ltd.), thereby evaluating the light transmittance. It is meant that the smaller the HAZE value, the better the light transmittance.

Evaluation criteria of the light transmittance are shown below.

Good: The haze value is less than 20.

Not bad: The haze value is 20 or more and less than 25.

Poor: The haze value is 25 or more.

### [Comprehensive Evaluation]

Evaluation criteria of the comprehensive evaluation are shown below.

Good: Favorable. In all of the evaluation results, neither the “Poor” rating nor the “Not bad” rating is present.

Not had: No problem on practical use. In all of the evaluation results, the “Poor” rating is not present, but the “Not bad” rating is present in one or more items.

Poor: Poor. In the evaluation results, the “Poor” rating is present in at least one item.

The evaluation results of the thus evaluated storage stability, fixability, fixing strength and light transmittance and the comprehensive evaluation are shown in Table 2.

TABLE 2

| | | | | | Compre- |
|---|---|---|---|---|---|
| | Storage | | Fixing | Light | hensive |
| | stability | Fixability | strength | transmittance | evaluation |
| Example 1 | Good | Good | Good | Good | Good |
| Example 2 | Good | Not bad | Good | Not bad | Not bad |
| Example 3 | Good | Good | Good | Good | Good |
| Example 4 | Good | Good | Good | Good | Good |
| Comparative | — | — | — | — | Poor |
| Example 1 | | | | | |
| Comparative | Poor | Poor | Poor | Not bad | Poor |
| Example 2 | | | | | |
| Comparative | Poor | Not bad | Poor | Not bad | Poor |
| Example 3 | | | | | |
| Comparative | Poor | Not bad | Poor | Not bad | Poor |
| Example 4 | | | | | |
| Comparative | Not bad | Poor | Poor | Not bad | Poor |
| Example 5 | | | | | |
| Comparative | Good | Poor | Poor | Poor | Poor |
| Example 6 | | | | | |
| Comparative | Not bad | Poor | Poor | Not bad | Poor |
| Example 7 | | | | | |
| Comparative | Good | Poor | Poor | Poor | Poor |
| Example 8 | | | | | |

It is clear from the results as shown in Table 2 that in comparison with the toners of Comparative Examples 1 to 8, the toners of Examples 1 to 4 according to the invention are excellent as described below.

The toners of Examples 1 to 4 each include the polyester resin A which is a major component and any one of the polylactic acid resins A to C, each of which is a crystalline resin, in the binder resin; and the crystalline resin is contained in an amount of 1 part by weight or more and 50 parts by weight or less based on 100 parts by weight of the binder resin, and the melting point is higher by a temperature of from 5° C. to 10° C. than a temperature at which the loss modulus G″ at a frequency of 1 Hz is 10³ Pa. Hence, the toners of Examples 1 to 4 revealed good results with respect to the storage stability, fixability, fixing strength and light transmittance.

On the other hand, in Comparative Example 1, since the amount of the polylactic acid resin A which is a crystalline resin was excessively large as 60 parts by weight based on 100 parts by weight of the binder resin, the binder resin became excessively rigid so that melt-kneading could not be achieved. Accordingly, it was impossible to achieve the evaluations.

In the toners of Comparative Examples 2 to 4, since melt-kneading was carried out using the extruder, the polylactic acid was not sufficiently dispersed in the toner. Hence, the melting point (Tm) of the crystalline resin exceeded a temperature higher by 10° C. than a temperature at which the loss modulus G″ at a frequency of 1 Hz is 10³ Pa. Accordingly, good results were not obtained with respect to the storage stability, fixability, fixing strength and light transmittance.

In the toners of Comparative Examples 5 and 7, the polyester resins B and D were used, respectively as the resin which is a major component of the binder resin. Hence, the melting point (Tm) of each of the crystalline resins exceeded a temperature higher by 10° C than a temperature at which the loss modulus G″ at a frequency of 1 Hz is 10³ Pa. Accordingly, the loss tangent exceeded 10, and good results were not obtained with respect to the storage stability, fixability, fixing strength and light transmittance.

In the toners of Comparative Examples 6 and 8, the polyester resin C was used as the resin which is a major component of the binder resin. Hence, the melting point (TM) of the crystalline resin was lower than a temperature higher by 5° C. than a temperature at which the loss modulus G″ at a frequency of 1 Hz is 10³ Pa, and the light transmittance was deteriorated. Also, the loss modulus G″ (at 120° C.) exceeded 10⁵ Pa, and the fixability and the fixing strength were deteriorated.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A toner comprising at least a binder resin and a colorant,
the binder resin including a resin which is a major component, and a biomass-containing crystalline resin, and
the crystalline resin being contained in an amount of 1 part by weight or more and 50 parts by weight or less based on 100 parts by weight of the binder resin, and a melting point of the crystalline resin being higher by a temperature of from 5° C. to 10° C. than a temperature at which a loss modulus G″ of the toner at a frequency of 1 Hz is 10³ Pa.

2. The toner of claim 1, wherein the crystalline resin includes a unit represented by the following formula (1)
—[O—CH(CH₃)—CO]ₙ— (1)
wherein n represents a positive integer.

3. The toner of claim 1, wherein the resin which is a major component is a polyester resin.

4. The toner of claim 1, wherein a loss modulus G″ of the toner at 120° C. is 10⁵ Pa or less, and a loss modulus G″ of the toner at 200° C., is 10¹ Pa or more, and a loss tangent which is a value obtained by dividing the loss modulus G″ at 200° C. by a storage modulus G′ is 10 or less.

5. A method for manufacturing the toner of claim 1, comprising:
a premixing step of mixing a binder resin which includes at least a resin which is a major component, and a biomass-containing crystalline resin and a colorant to prepare a mixture;
a melt-kneading step of melt-kneading the mixture containing the crystalline resin in an amount of 1 part by weight or more and 50 parts by weight or less based on 100 parts by weight of the binder resin to prepare a melt-kneaded material;
a pulverization step of pulverizing the melt-kneaded material to prepare a pulverized material; and
a classification step of removing an excessively-pulverized material and a coarse powder from the pulverized material.

6. The method of claim 5, wherein the mixture is melt-kneaded using a two-roller type continuous kneading machine in the melt-kneading step.

7. A two-component developer comprising the toner of claim 1 and a carrier.

8. A developing device performing development by use of the toner of claim 1.

9. An image forming apparatus comprising the developing device of claim 8.

10. The image forming apparatus of claim 9, further comprising a fixing section for heat-melting and fixing a toner image formed on a recording medium.
